(19) United States
(12) Patent Application Publication
(10) Pub. No.: US 2020/0043074 A1
(43) Pub. Date: Feb. 6, 2020

(54) APPARATUS AND METHOD OF RECOMMENDING ITEMS BASED ON AREAS

(71) Applicant: MYCELEBS CO., LTD., Seoul (KR)

(72) Inventor: Jun Woong DOH, Seoul (KR)

(21) Appl. No.: 16/529,242

(22) Filed: Aug. 1, 2019

(30) Foreign Application Priority Data
Aug. 1, 2018 (KR) 10-2018-0089950

(51) Int. Cl. G06Q 30/06; G06Q 50/12

(52) U.S. Cl. CPC G06Q 30/0631; G06Q 30/0639; G06Q 50/12

(57) ABSTRACT

The present disclosure is related to an apparatus and a method of recommending items based on areas which recommend items according to an area, a preference filter, and a category input by a user.

### CROSS-REFERENCE TO RELATED APPLICATION

This application claims priority under 35 U.S.C. § 119 to Korean Patent Application No. 10-2018-0089950, filed on Aug. 1, 2018, in the Korean Intellectual Property Office (KIPO), the disclosure of which is incorporated by reference herein in its entirety.

### 1. TECHNICAL FIELD

Embodiments of the present invention relate to an apparatus and a method of recommending items based on areas, and more particularly, to an apparatus and a method of recommending items based on areas which recommend items according to an area, a preference filter, and a category input by a user.

### 2. DISCUSSION OF RELATED ART

According to conventional search methods, a user can search for a desired web document or the like by entering a search keyword into a search box. For example, a user may retrieve information about the movie “Interstellar” by entering the title of the movie “Interstellar” into the search box. However, if a user cannot remember the title of a movie which he or she desires to search for, he or she needs to provide another type of information. For example, a user may attempt a search by entering an actor, director, producer, or the like of a movie which he or she desires to search for. There are many cases where movie information sites and movie review sites provide cast information as well as movie information, and thus the user can search for a desired movie by using an actor, a director, a producer, or the like as a keyword unless he or she is unlucky.

Meanwhile, the conventional search methods cannot be used if information to be used is information based on an atypical language, for example, an emotional language, rather than typical information. For example, responses provided by conventional search engines for a search term, such as “a funny movie” or “a movie which is viewed when a viewer is sad,” are merely search results, including documents which have been written to include the keyword “a funny movie” or “a movie viewed when a viewer is sad.” However, an atypical language requires an approach different from that for typical information, such as a starring actor, a (typical) movie genre, and a year of release. Even if documents have not been written to include the keyword “a funny movie” or “a movie viewed when a viewer is sad,” there could be a lot of movies for which many people might feel is “fun” or “sad.” Furthermore, for other fields than film, a different approach may be required for requesting information by using an atypical language.

Meanwhile, when searching for accommodations in a travel or sightseeing destination, accommodation in the corresponding area is searched in a portal site, an Internet cafe, or a blog, and comments and reviews on the accommodation are checked to determine the accommodation.

In this case, not only does it take a considerable amount of time to read the reviews or comments, but opinions of some travelers or tourists may only be checked, and thus there may be cases where an accommodation that does not match the user's preferences is selected.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Embodiments of the present invention may be directed to an apparatus and a method of recommending items based on areas which recommend items according to an area, a preference filter, and a category input by a user.

According to an embodiment, an apparatus of recommending items based on areas includes: a display unit which comprises: an area input part for receiving an input of an area, a preference filter selection part for displaying preference filters associated with the input area and items of the input area, and receiving a selection of preference filters, and a category selection part for receiving a selection of categories associated with the item; and a control unit for controlling the display unit and transmitting the input area, the selected preference filter, the selected category to an information provision apparatus.

The item may be an accommodation.

The category may be at least one of a hotel, a motel, a pension, and a guest house.

A predetermined number of preference filters may be displayed in descending order of a degree of preference filter-item association in the area.

The display unit may further include: a preference filter display part for displaying the selected preference filter; and a recommendation result display part for receiving, from the information provision apparatus, an item that has a high degree of preference filter-item association with the selected preference filter in the area, and displaying the item.

The apparatus may display an item that is recommended as a part of the selection of preference filters is canceled, or as a preference filter is added.

The preference filter associated with the item may be selected based on at least one of a distance between the item and the preference filter and a frequency of the accommodation and the preference filter being described at a time in documents.

According to an embodiment, a method of recommending items based on areas includes: receiving an area selected by a user; calculating a degree of association of preference filters to items in the area to determine preference filters; and transmitting, to a terminal, a predetermined number of preference filters of the determined preference filters.

The method may further include: receiving a selection of preference filters of the preference filters transmitted to the terminal.

The method may further include: receiving a category for the item.

The method may further include: recommending items based on the selected preference filter, the area, and the category and transmitting the recommending items.

The items may be recommended and transmitted in descending order of a degree of preference filter-item association.

The item may be an accommodation.

The category may be at least one of a hotel, a motel, a pension, and a guest house.

A predetermined number of preference filters may be displayed in descending order of a degree of preference filter-item association in the area.

The preference filter associated with the item may be selected based on at least one of a distance between the item and the preference filter and a frequency of the accommodation and the preference filter being described at a time in documents.

A degree of association of a preference filter to the area may be calculated by adding degrees of association between the preference filter and all accommodations in the area.

A degree of association of a preference filter to the area may be set to have a positive correlation with degrees of association between the preference filter and all accommodations in the area.

The foregoing is illustrative only and is not intended to be in any way limiting. In addition to the illustrative aspects, embodiments and features described above, further aspects, embodiments and features will become apparent by reference to the drawings and the following detailed description.

### BRIEF DESCRIPTION OF THE DRAWINGS

A more complete appreciation of the present invention will become more apparent by describing in detail embodiments thereof with reference to the accompanying drawings, wherein:

FIG. 1 is a view showing the network configuration of a system for providing information by using an attribute language according to an exemplary embodiment of the present disclosure;

FIG. 2 is a block diagram of a terminal according to an exemplary embodiment of the present disclosure;

FIG. 3 is a block diagram of an information provision apparatus according to an exemplary embodiment of the present disclosure;

FIG. 4 is a flowchart of a process of providing information via an information provision interface according to an exemplary embodiment of the present disclosure;

FIG. 5 is a detailed flowchart of step 910 according to an exemplary embodiment of the present disclosure;

FIG. 6 is a detailed flowchart of step 510 according to an exemplary embodiment of the present disclosure;

FIG. 7 is a detailed flowchart of step 530 according to an exemplary embodiment of the present disclosure;

FIG. 8 is a flowchart of a process of providing information according to another exemplary embodiment of the present disclosure;

FIG. 9 is a flowchart of a process of providing information according to another exemplary embodiment of the present disclosure;

FIG. 10 shows an example of the stored degrees of object-keyword association according to an exemplary embodiment of the present disclosure;

FIG. 11 shows an example of the degrees of basic reserved word-keyword association according to an exemplary embodiment of the present disclosure;

FIG. 12 is a detailed flowchart of step 940 according to an exemplary embodiment of the present disclosure;

FIG. 13 is a flowchart of a process of providing information according another exemplary embodiment of the present disclosure;

FIG. 14 is a flowchart of a process of providing information according to still another exemplary embodiment of the present disclosure;

FIG. 15 is a detailed flowchart of step 1340 according to a first exemplary embodiment of the present disclosure;

FIG. 16 is a detailed flowchart of step 1340 according to another exemplary embodiment of the present disclosure;

FIG. 17 is a detailed flowchart of step 1340 according to still another exemplary embodiment of the present disclosure;

FIG. 18 is a detailed flowchart of step 1320 according to a modified exemplary embodiment of the present disclosure;

FIG. 19 is an example of an interface generated based on the interface information provided at step 1840;

FIG. 20 is a view of a terminology hierarchy according to an exemplary embodiment of the present disclosure;

FIG. 21 is a flowchart of a process of installing a virtual input interface program according to an embodiment;

FIG. 22 is a view of an interface page of a package for performing a method of recommending items based on areas according to an embodiment;

FIG. 23 is a view of an area input part of an interface page of a package for performing a method of recommending items based on areas according to an embodiment; and

FIG. 24 is a view of an interface page of a package for performing a method of recommending items based on areas according to another embodiment.

### DETAILED DESCRIPTION

Embodiments of the present disclosure will be described in detail below with reference to the accompanying drawings.

In descriptions of the embodiments, descriptions of techniques which are well known in the art to which this disclosure belongs and which are not directly related to this disclosure will be omitted. The reason for this is to more clearly convey the gist of the present disclosure without making the gist of the present disclosure obscure by omitting unnecessary descriptions.

For the same reason, in the accompanying drawings, some components are exaggerated, omitted, or schematically shown. Also, the size of each component does not completely reflect the actual size thereof. Throughout the drawings, the same or corresponding components are denoted by the same reference symbols.

The exemplary embodiments of the present disclosure are described in detail below with reference to the accompanying drawings.

According to some embodiments of the present invention, a reserved word may mean a character string that can be expressed or defined through association information with other keywords, or a character, a utilization mode, a property and the like thereof can be expressed and defined. However, it is also possible that a reserved word defined/expressed in another manner, for example, according to a manual input of an administrator, is applied to the present invention. The detailed configuration of the association information will be described below.

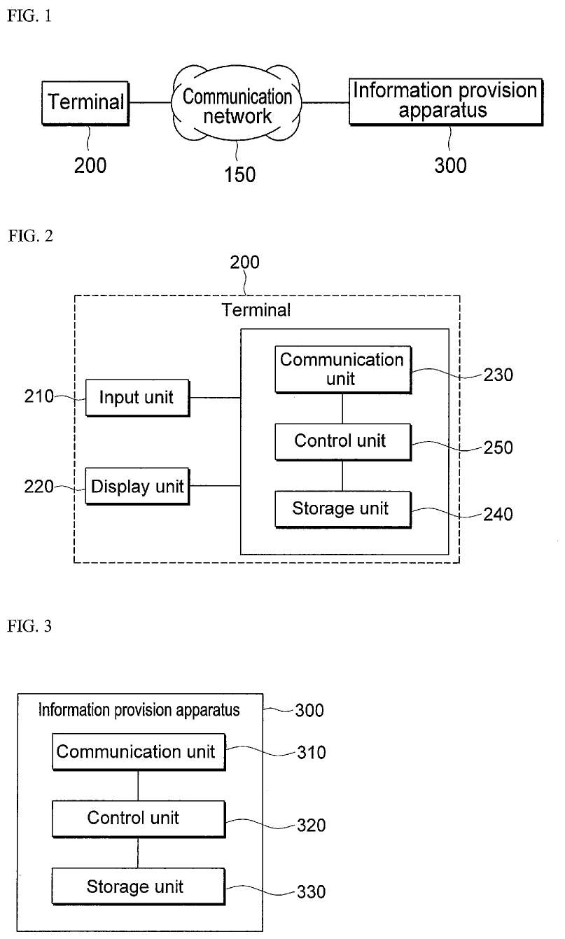

FIG. 1 is a view showing the network configuration of a system for providing information by using an attribute language according to an exemplary embodiment of the present disclosure.

Referring to FIG. 1, the information provision system according to the present exemplary embodiment may include a terminal 200, an information provision apparatus 300, and a communication network 150.

Terminal 200 may be implemented as, e.g., a smartphone, a PDA, a tablet PC, a notebook computer, a laptop computer, a personal computer, another electronic device capable of performing communication, receiving input from a user, and outputting screens, or a similar device.

The information provision apparatus 300 may be implemented as, e.g., a workstation, a server, a general-purpose computer, another electronic device capable of performing communication, or a similar device.

The terminal 200 and the information provision apparatus 300 are connected to and communicate with each other over the communication network 150.

The communication network 150 may be implemented using at least part of Long Term Evolution (LTE), LTE-Advanced (LTE-A), WI-FI, Local Area Network (LAN), Wide Area Network (WAN), Code Division Multiple Access (CDMA), Time Division Multiple Access (TDMA), Wireless Broadband (WiBro), and Global System for Mobile Communications (GSM), and other communication methods developed in the past, being currently developed, and to be developed in the future. In the following, for the sake of convenience, the terminal 200 and the information provision apparatus 300 will be described as directly communicating with each other without references to the communication network 150.

The detailed operations and configurations of the terminal 200 and the information provision apparatus 300 will be described with reference to FIGS. 2 to 8.

FIG. 2 is a block diagram of a terminal 200 according to an exemplary embodiment of the present disclosure.

Referring to FIG. 2, the terminal 200 according to the present exemplary embodiment may include an input unit 210, a display unit 220, a communication unit 230, a storage unit 240, and a control unit 250.

The input unit 210 converts an input operation of a user into an input signal, and transmits the input signal to the control unit 250. The input unit 210 may be implemented as, e.g., a keyboard, a mouse, a touch sensor on a touch screen, a touchpad, a keypad, a voice input device, or another input processing device developed in the past, being currently developed, or to be developed in the future. For example, the input unit 210 may receive information provision request input from a user, and may transfer the information provision request input to the control unit 250.

The display unit 220 outputs a screen under the control of the control unit 250. The display unit 220 may be implemented as, e.g., a liquid crystal display (LCD) device, a light-emitting diode (LED) device, an organic LED (OLED) device, a projector, or another display device developed in the past, being currently developed, or to be developed in the future. For example, the display unit 220 may display an interface page or information provision result page for the provision of information. In an exemplary embodiment, a component using another method capable of transferring information to a user, such as voice output or vibration, rather than screen output, may be used in place of the display unit 220.

The communication unit 230 exchanges data with the information provision apparatus 300 and/or other external devices. The communication unit 230 transfers data, received from the information provision apparatus 300, to the control unit 250. Furthermore, the communication unit 230 transfers data to the information provision apparatus 300 under the control of the control unit 250. The communication technology used by the communication unit 230 may vary depending on the type of communication network 150 or other circumstances.

The storage unit 240 stores data under the control of the control unit 250, and transfers requested data to the control unit 250.

The control unit 250 controls the overall operation of the terminal 200 and individual components. In particular, the control unit 250 transmits an information provision request or another type of data to the information provision apparatus 300 according to information input from the input unit 210, and displays a result page and/or an interface page via the display unit 220 according to page information received from the information provision apparatus 300, as will be described later.

The operation performed by the control unit 250 may be distributed and processed by a plurality of arithmetic and logic units which are physically distributed. There is possible a method in which part of the operation performed by the control unit 250 is performed by a first server and the remaining operation is performed by a second server. In this case, the control unit 250 may be implemented as the sum of the arithmetic and logic units which are physically distributed.

The storage unit 240 may be implemented as the sum of storage devices which are physically separated from each other.

When the control unit 250 or storage unit 240 is implemented as the sum of a plurality of devices which are physically separated from each other, communication is required between the plurality of devices. In this case, for the sake of simplicity of description, the following description will be given on the assumption that the storage unit 240 or control unit 250 is implemented as a single object.

In the case where the terminal 200 transmits or receives data, the communication unit 230 may be described as transmitting or receiving data under the control of the control unit 250, or the control unit 250 may be described as transmitting or receiving data by controlling the communication unit 230, depending on the point of view of a corresponding situation.

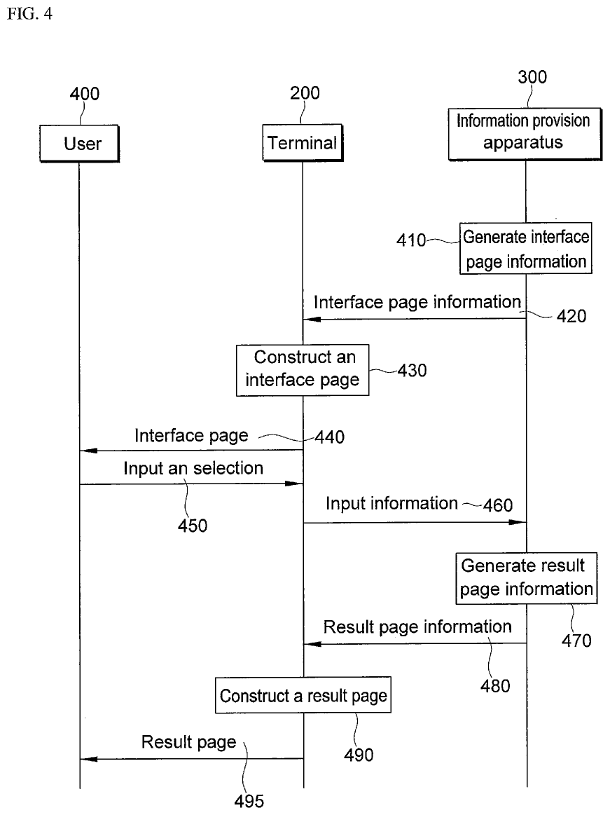

The detailed operations of the individual components of the terminal 200 will be described with reference to FIGS. 4 to 8.

FIG. 3 is a block diagram of an information provision apparatus 300 according to an exemplary embodiment of the present disclosure.

Referring to FIG. 3, the information provision apparatus 300 according to the present exemplary embodiment may include a communication unit 310, a control unit 320, and a storage unit 330.

The communication unit 310 exchanges data with the terminal 200 and/or other external devices. The communication unit 310 transfers data, received from the terminal 200, to the control unit 320. Furthermore, the communication unit 310 transfers data to the terminal 200 under the control of the control unit 320. The communication technology used by the communication unit 310 may vary depending on the type of communication network 150 or other circumstances.

The storage unit 330 stores data under the control of the control unit 320, and transfers data, requested by the control unit 320, to the control unit 320.

The control unit 320 controls the overall operation of the information provision apparatus 300 and individual components. In particular, when the control unit 320 receives an interface page request, an information provision result page request, or another type of data via the communication unit 310, the control unit 320 retrieves required data from storage unit 330, generates load page information, and transfers page information to the terminal 200 via the communication unit 310, as will be described later.

In the case where the information provision apparatus 300 transmits or receives data, the communication unit 310 may be described as transmitting or receiving data under the control of the control unit 320, or the control unit 320 may be described as transmitting or receiving data by controlling the communication unit 310, depending on the point of view of a corresponding situation.

Meanwhile, the storage unit 330 stores a program code for performing a method of recommending items based on areas, and/or an installation package (installation program code) for installing the program. Hereinafter, the program code for performing the method of recommending items based on areas and/or the installation package (installation program code) for installing the program are referred to as a virtual input interface program.

A developer or manager who develops the information provision apparatus 300 may store the virtual input interface program in the storage unit 330. When the information provision apparatus 300 receives a request message for requesting the virtual input interface program through the communication unit 310, the control unit 320 transmits the virtual input interface program to the terminal 200 through the communication unit 310.

The detailed operations of the individual components of the information provision apparatus 300 will be described with reference to FIGS. 4 to 8.

According to another exemplary embodiment, data adapted to provide information by using a voice form or another method may be transmitted and received in place of a page adapted to visually provide information.

FIG. 4 is a flowchart of a process of providing information via an information provision interface according to an exemplary embodiment of the present disclosure.

At step 410, the control unit 320 of the information provision apparatus 300 generates interface page information. The interface page is information required to generate an information interface page. The interface page is a page adapted to prompt the input of a user, to receive the input of the user, and to transfer the input of the user to the information provision apparatus 300. For example, the interface page information may be in the form of an HTML document or another markup language document. In another exemplary embodiment, the terminal 200 may have the form information of the interface page in advance, and only an item corresponding to content may be transferred from the information provision apparatus 300 to the terminal 200. In the following, for the sake of convenience, the following description will be given on the assumption that the interface page information or another type of page information is transferred in the form of an HTML document. However, the scope of the present disclosure is not limited thereto.

At step 420, the communication unit 310 of the information provision apparatus 300 transfers the interface page information to the terminal 200.

At step 430, the control unit 250 of the terminal 200 constructs an interface page by using the interface page information. For example, the control unit 250 may run a web browser, may interpret an HTML document, and may construct an interface page in the form of a web page. A separate application may be used in place of the web browser.

At step 440, the display unit 220 of the terminal 200 displays the interface page to a user 400. The interface page may include an interface in which, e.g., the user 400 may request the provision of information, may input and/or select a keyword for the provision of the information, and may make other settings for the provision of the information.

At step 450, the input unit 210 of the terminal 200 receives the selection input of the user 400 via the input interface page, and transfers the selection input to the control unit 250.

At step 460, the communication unit 230 of the terminal 200 transfers input information adapted to identify the selection input of the user 400 to the information provision apparatus 300 under the control of the control unit 250.

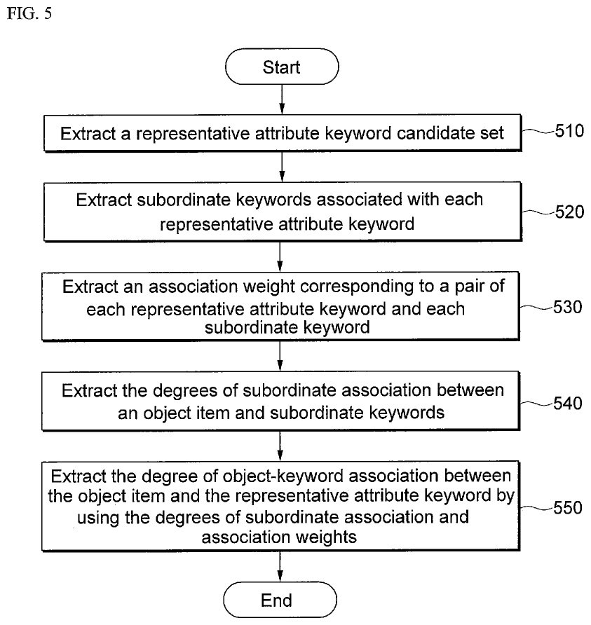

At step 470, the control unit 320 of the information provision apparatus 300 generates result page information by using the input (e.g., a keyword and/or another information provision setting) of the user 400. A preparation process of generating the result page information and a process of generating the result page information will be described with reference to FIGS. 5 to 8 later. The result page information may be constructed, e.g., in the form of an HTML document and/or in the form of an image.

At step 480, the communication unit 310 of the information provision apparatus 300 transfers the result page information to the terminal 200.

At step 490, the control unit 250 of the terminal 200 constructs a result page by using the result page information received by the communication unit 230. For example, the control unit 250 may construct a result page by interpreting the result page information in an HTML form.

At step 495, the display unit 220 of the terminal 200 provides the result page to the user 400.

Although it is assumed that a page in a visual form is provided to the user 400 in the exemplary embodiment of FIG. 4, the interface or result information may be provided by voice. In this case, a voice output unit may be used in place of the display unit 220. Another type of interface method available currently or in the future may be used in conjunction with the user 400 in place of the visual/aural method. In this case, the information provision apparatus 300 may provide information, obtained through conversion using another method, to the terminal 200 in place of the page information in accordance with the interface method.

In exemplary embodiments shown in the drawings starting from FIG. 5, the user 400 desires to receive information about an object in a specific field of interest in which he or she is interested in. However, the scope of the present disclosure is not limited thereto.

A field of interest may be, e.g., the type of objects. For example, when the field of interest is “Celebrity,” objects corresponding to this field of interest may include “Si-min Yu,” “Jae-seok Yu,” “Taylor Swift,” etc. For example, when the field of interest is “Movie,” objects corresponding to this field of interest may include “Dunkirk,” “Spider-Man: Homecoming,” “Despicable Me 3,” etc. For example, when the field of interest is “Broadcast program,” objects corresponding to this field of interest may include “Muhandogeon (Infinite Challenge),” “American Idol,” “Game of Thrones,” etc.

In the following exemplary embodiments, documents are collected in order to evaluate the relationship (the degree of association, weight, and/or the like) between keywords. The collected documents may be evaluated as having the same value, or a newer document may be evaluated as having a higher value. In other words, the degrees of association between the age of a document based on an evaluation date and keywords appearing in the document may have a negative correlation.

In the process starting from FIG. 5, the value may vary depending on the up-to-dateness of a document. For example, the degree of association of a case where two keywords appear in a document which is one day old at evaluation time may be evaluated as being ten times higher than that of a case where two keywords appear in a document which is ten days old at the evaluation time. The age of a document may be evaluated, e.g., on a second/minute/hour basis or on a day/month/year basis. Although the control unit 320 is based on a document evaluated before the age of the document is reflected therein, the control unit 320 may extract the degree of association between two keywords by extracting the partial degree of association reflecting the age of the document through the division of the value of the partial degree of association by the age of the document and then accumulating the partial degrees of association.

The time at which a document was generated, which is used to determine the age of the document, may be determined using, e.g., a posting time included inside the document and/or metadata. Alternatively, when a document which had not been found during previous crawling is newly found through periodic crawling, it is determined that a new document is added at new crawling time.

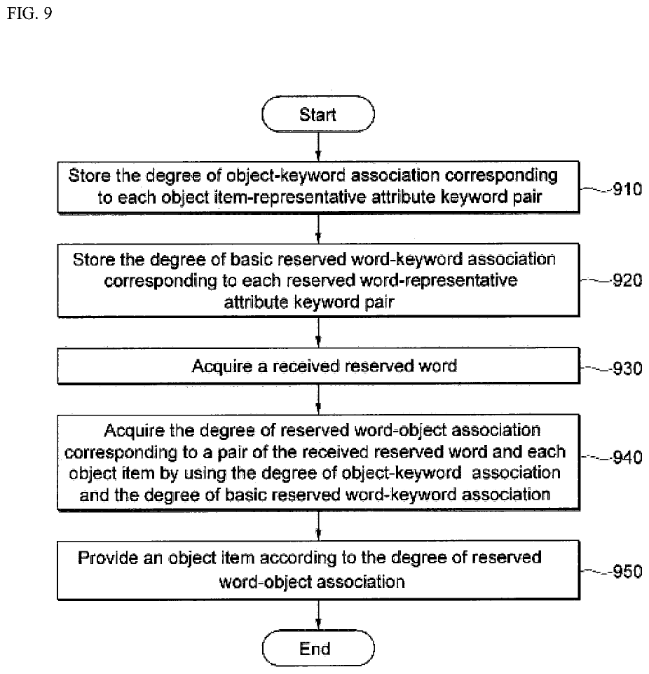

FIG. 9 is a flowchart of a process of providing information according to an exemplary embodiment of the present disclosure.

At step 910, the control unit 320 stores the degree of object-keyword association corresponding to each object item-representative attribute keyword pair in the storage unit 330.

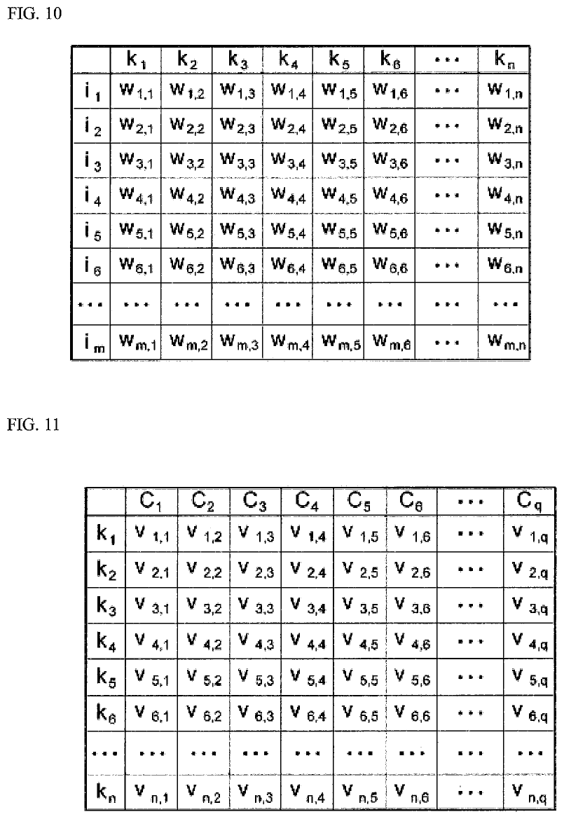

FIG. 10 shows an example of the stored degrees of object-keyword association according to an exemplary embodiment of the present disclosure.

In the exemplary embodiment of FIG. 10, object items are all in m (i₁ to iₘ) in number, and representative attribute keywords are all n (k₁ to kₙ) in number.

For example, the degree of object-keyword association between the object item i₅ and the representative attribute keyword k₃ is w_{5,3}.

The process of step 910 may be performed, e.g., according to part of the exemplary embodiments of FIGS. 5 to 8, a similar process, or an equivalent process. According to another exemplary embodiment, the process of step 910 may be performed by the input of an administrator, or by receiving the degree of object-keyword association, determined by an external system, via a network or storage medium.

FIG. 5 is a detailed flowchart of step 910 according to an exemplary embodiment of the present disclosure.

Referring to FIG. 5, at step 510, the control unit 320 extracts a representative attribute keyword candidate set from first set documents. For example, the control unit 320 may collect keywords, frequently appearing in the documents of the first set documents corresponding to a field of interest, as a representative attribute keyword candidate set.

FIG. 6 is a detailed flowchart of step 510 according to an exemplary embodiment of the present disclosure.

The control unit 320 may select keywords appearing in the same documents as object keywords representative of object items belonging to a specific field and keywords appearing in the same documents as field keywords representative of a specific field as a first attribute keyword candidate set and a second attribute keyword candidate set.

For example, when a target field of interest for the provision of information provision service is “Celebrity,” field keywords may include “celebrity,” “entertainer,” “movie star,” “star,” “celeb,” etc. The field keywords may be set by an administrator, and may be recommended and set by the control unit 320. The control unit 320 may acquire some field keywords, and may then recommend and set similar keywords, whose degree of association with each of the field keywords is analyzed as being equal to or larger than a preset value, as additional field keywords.

When a target field of interest for the provision of information provision service is “Celebrity,” object keywords may be individual persons belonging to the corresponding field of interest. For example “Jae-seok Yu,” “Taylor Swift,” “Stephen Curry,” etc. may be object keywords corresponding to the field of interest “Celebrity.”

The relationship between a field keyword and an object keyword is now described. For example, a field keyword may correspond to the attribute or type of corresponding object keyword. A field keyword may be representative of a set, whereas an object keyword may be representative of an element belonging to a corresponding set.

Object keywords may be set by an administrator, and may be selected using a method similar to the method of selecting field keywords. According to still another exemplary embodiment, the control unit 320 may select keywords, determined to be elements of a set represented by a field keyword, as object keywords by analyzing the contexts of collected documents.

A popular object keyword and an unpopular object keyword may be distinguished from each other based on the quantities of the found/collected corresponding object keywords. The control unit 320 may search for/collect documents containing each object keyword, and may set an object keyword, for which the quantity of collected documents is equal to or larger than a specific threshold value, as a popular object keyword and set an object keyword, for which the quantity of collected documents is smaller than a specific threshold value, as an unpopular object keyword.

A popular field keyword and an unpopular field keyword may be distinguished from each other based on the quantities of the found/collected corresponding field keywords. The control unit 320 may search for/collect documents containing each field keyword, and may set a field keyword, for which the quantity of collected documents is equal to or larger than a specific threshold value, as a popular field keyword and set a field keyword, for which the quantity of collected documents is smaller than a specific threshold value, as an unpopular field keyword. However, the threshold value used to distinguish the popular object keyword and the unpopular object keyword from each other and the threshold value used to distinguish the popular field keyword and the unpopular field keyword from each other may be different values. In the following, for the sake of convenience, a popular object keyword and a popular field keyword may be collectively called a popular field/object keyword. Furthermore, for the sake of convenience, an unpopular object keyword and an unpopular field keyword may be collectively called an unpopular field/object keyword.

In a modified exemplary embodiment, only a popular field keyword or popular object keyword may be used in place of a popular field/object keyword. In a modified exemplary embodiment, only an unpopular field keyword or unpopular object keyword may be used in place of an unpopular field/object keyword.

At step 610, the control unit 320 sets keywords, appearing in the same documents as a popular field/object keyword, for a first attribute keyword candidate set.

The control unit 320 may search for/collect documents containing a popular field/object keyword, and may set keywords, included in the collected documents, for a first attribute keyword candidate set. According to another exemplary embodiment, the control unit 320 may exclude field keyword and object keywords among the keywords included in the collected documents from the first attribute keyword candidate set. Furthermore, the control unit 320 may exclude a preset insignificant keyword, e.g., a postpositional particle/article, from the first attribute keyword candidate set. Furthermore, according to another exemplary embodiment, the control unit 320 may include a keyword, registered in a preset dictionary, among the keywords included in the collected documents in a first attribute keyword candidate set.

Furthermore, according to another exemplary embodiment, the control unit 320 may search for/collect documents containing a popular field/object keyword, and may include keywords, disposed within a preset distance from a popular field/object keyword or a sentence containing the keyword in the collected documents, in a first attribute keyword candidate set. Furthermore, according to another exemplary embodiment, the control unit 320 may search for/collect documents containing a popular field/object keyword, and may include keywords, used to describe and modify the popular field/object keyword, in a first attribute keyword candidate set by analyzing the contexts of the collected documents.

The distance between keywords or the distance between a keyword and a sentence may be determined based on, e.g., any one or more of the number of sentences located between the two keywords or between the keyword and the sentence, the number of words located between the two keywords or between the keyword and the sentence, the number of phases located between the two keywords or between the keyword and the sentence, and the number of letters located between the two keywords or between the keyword and the sentence.

The control unit 320 may first perform morpheme analysis in order to perform keyword analysis.

At step 620, the control unit 320 sets keywords, appearing in the same documents as an unpopular field/object keyword, for a second attribute keyword candidate set.

The control unit 320 may search for/collect documents containing an unpopular field/object keyword, and may set keywords, included in the collected documents, for a second attribute keyword candidate set. According to another exemplary embodiment, the control unit 320 may exclude a field keyword and an object keyword among keywords included in the collected documents from the second attribute keyword candidate set. Furthermore, the control unit 320 may exclude a preset insignificant keyword, e.g., a postpositional particle/article and/or the like, from the second attribute keyword candidate set. Furthermore, according to another exemplary embodiment, the control unit 320 may include a keyword, registered in a preset dictionary, among the keywords included in the collected documents in a second attribute keyword candidate set.

Furthermore, according to another exemplary embodiment, the control unit 320 may search for/collect documents containing an unpopular field/object keyword, and may include keywords, disposed within a preset distance from an unpopular field/object keyword or a sentence containing the keyword in the collected documents, in a second attribute keyword candidate set. Furthermore, according to another exemplary embodiment, the control unit 320 may search for/collect documents containing an unpopular field/object keyword, and may include keywords, used to describe and modify the unpopular field/object keyword, in a second attribute keyword candidate set by analyzing the contexts of the collected documents.

The distance between keywords or the distance between a keyword and a sentence may be determined based on, e.g., any one or more of the number of sentences located between the two keywords or between the keyword and the sentence, the number of words located between the two keywords or between the keyword and the sentence, the number of phases located between the two keywords or between the keyword and the sentence, and the number of letters located between the two keywords or between the keyword and the sentence.

The control unit 320 may first perform morpheme analysis in order to perform keyword analysis.

At step 630, the control unit 320 may set keywords belonging to both the first attribute keyword candidate set and the second attribute keyword candidate set for a representative attribute keyword candidate set. In other words, keywords used to modify both a popular field/object keyword and an unpopular field/object keyword may be collected as the representative attribute keyword candidate set.

According to another exemplary embodiment, at step 510, the control unit 320 may include keywords each appearing along with an object keyword and/or a field keyword in the representative attribute keyword candidate set regardless of the popularity/unpopularity thereof.

Referring back to FIG. 5, at step 520, the control unit 320 extracts two or more subordinate keywords, associated with each representative attribute keyword included in the representative attribute keyword candidate set, from the second set documents.

The second set documents used for the subordinate keyword extraction of step 520 and the first set documents used for the representative attribute keyword candidate set extraction of step 510 may be different document sets, or may be the same document set. For example, the first set documents may be a set including all collectable documents, and the second set documents may be a set including only documents in which a specific target field of interest for the provision of information provision service is used as a main keyword. The control unit 320 may analyzes whether or not each document is a document in which a specific target field of interest for the provision of information provision service is used as a main keyword based on frequently appearing keywords by analyzing collectable documents. According to another exemplary embodiment, the first set documents and the second set documents may be all sets each including all collectable related documents. Furthermore, according to another exemplary embodiment, the first set documents may be a set including all collectable related documents, and the second set documents may be a set including only documents related to a specific target field of interest for the provision of information provision service. Furthermore, according to another exemplary embodiment, the second set documents may be a set including all collectable related documents, and the first set documents may be a set including only documents related to a specific target field of interest for the provision of information provision service.

For step 520, the control unit 320 may collect documents including a keyword representative of a specific target field of interest itself and/or documents each including an object keyword belonging to the corresponding field of interest, e.g., in order to generate a set including only documents related to the specific field of interest for the provision of information provision service, extracts documents in which the weight of a field keyword/object keyword is equal to or larger than a preset value, from among the collected documents, and may generate a set including only documents related to the specific field of interest. The weight of the field keyword/object keyword may be determined based on the appearing frequency or appearing locations of the field keyword/object keyword, context, or the like. For example, a document in which the field keyword/object keyword appears frequently, is used as the title of the corresponding document, or is described in large letters or emphasizing fonts may be classified as a document related to the specific field of interest.

At step 520, the control unit 320 may extract a preset number of subordinate keywords each having a high degree of association with each representative attribute keyword by, e.g., analyzing at least part of the second set documents, thereby extracting two or more subordinate keywords associated with each representative attribute keyword.

The control unit 320 may determine the degree of association between a representative attribute keyword and a subordinate keyword, e.g., by taking into account the frequency at which the subordinate keyword appears in the same or similar context as the representative attribute keyword. For example, words appearing near keyword A in a specific sentence may be viewed as also appearing near a word associated with keyword A in another document.

“I went on a trip after making a hard decision, but it was July and, thus, the weather was so hot that I suffered.”

“I went on a trip after making a hard decision, but it was July and, thus, the weather was so humid that I suffered.”

Referring to the above two sentences, the word “hot” is replaced with the word “humid” in the same context. The control unit 320 may infer that “hot” and “humid” are associated words.

“I went on a trip after making a hard decision, but it was July and, thus, the weather was so hot that I suffered.”

“I went on vacation after making a hard decision, but it was July and, thus, the weather was so hot that I suffered.”

In the same manner, the control unit 320 may infer from the above two sentences that “trip” and “vacation” are associated words.

“I went on a trip after making a hard decision, but it was July and, thus, the weather was so hot that I suffered.”

“I went on a trip after making a hard decision, but it was August and, thus, the weather was so hot that I suffered.”

In the same manner, the control unit 320 may infer that “July” and “August” are associated words.

The control unit 320 may stores information in which “hot” and “humid” are associated words, “July” and “August” are associated words, and “trip” and “vacation” are associated words via previously collected documents. Thereafter, it is assumed that the following sentences are collected.

“I went on vacation after making a hard decision, but it was July and, thus, the weather was so hot that I suffered.”

“I went on a trip after making a hard decision, but it was August and, thus, the weather was so hot that I went through hardship.”

When the two sentences do not have the same context but it is known that “hot” and “humid” are associated words, “July” and “August” are associated words, and “trip” and “vacation” are associated words, the control unit 320 may learn that “suffer” and “hardship” are also associated words via the above sentences.

It may be determined that a keyword pair having a high appearing frequency in the same/similar contexts has a high degree of association. Furthermore, it is determined that the higher the similarity between contexts in which two keywords appear is, the higher the degree of association between the two keywords is. The control unit 320 may increase the accuracy of the determination of the degrees of association between keywords in such a manner as to set the degrees of association keywords by performing learning by using collected documents and then setting the degrees of association between keywords appearing in a corresponding sentence by using the set degrees of association between keywords and the context of the sentence.

As similar learning methods, Neural Net Language Model (NNLM), Recurrent Neural Net Language Model (RNNLM), word2vec, skipgram, and Continuous Bag-of-Words (CBOW) methods are known. In particular, when the word2vec method is used, the word2vec method can map individual keywords to vectors by performing learning by using documents, and can determine the similarity between two keywords through the cosine similarity calculation of two vectors.

By means of such a method or a similar method, the control unit 320 may extract a preset number of subordinate keywords having the highest degree of association with each representative attribute keyword by analyzing at least part of the second set documents.

At step 530, the control unit 320 may extract an association weight corresponding to a pair of each representative attribute keyword within the representative attribute keyword candidate set and each subordinate keyword from the second set documents.

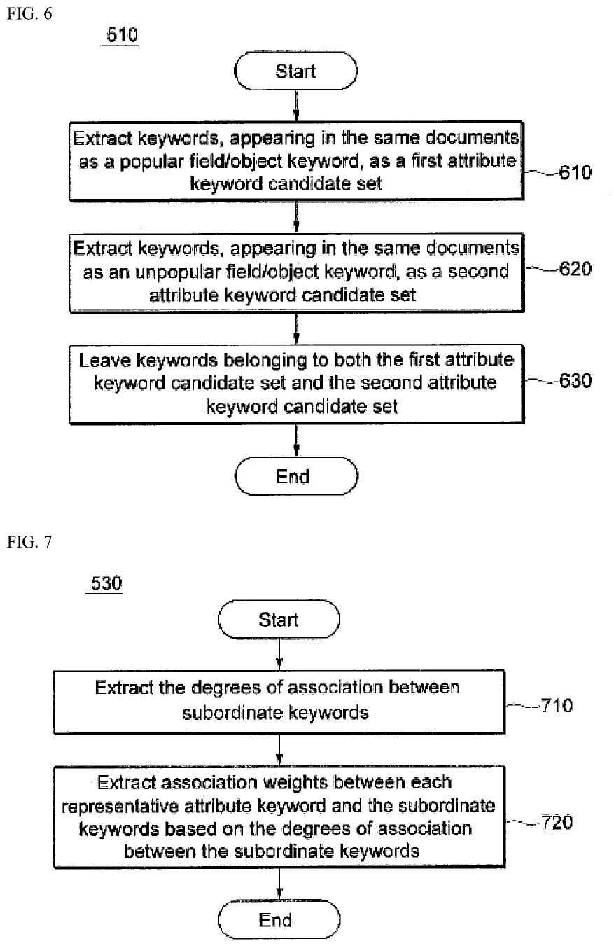

FIG. 7 is a detailed flowchart of step 530 according to an exemplary embodiment of the present disclosure.

At step 710, the control unit 320 may extract the degrees of association between the subordinate keywords by analyzing at least part of the second set documents. For example, it is assumed that subordinate keywords collected as subordinate keywords associated with representative attribute keyword A1 are 50 subordinate keywords B1₁ to B1₅₀. In this case, the control unit 320 may extract the degree of association between two subordinate keywords by using the frequency at which the two subordinate keywords appear in the same document, for these 50 subordinate keywords. The degree of association between B1₁ and B1₂ is determined based on the frequency at which B1₁ and B1₂ appear in the same document. According to another exemplary embodiment, the frequency at which B1₁ and B1₂ appear in the same document influences the degree of association, and, additionally, in the case where B1₁ and B1₂ appear in the same document, as the distance between the two keywords B1₁ and B1₂ (or the distance between the sentences in which two keyword appear) is closer, a higher degree of association may be recognized. In a similar method, the degrees of association between subordinate keywords may be extracted. The distance between keywords or the distance between a keyword and a sentence may be determined based on, e.g., any one or more of the number of sentences located between the two keywords or between the keyword and the sentence, the number of words located between the two keywords or between the keyword and the sentence, the number of phases located between the two keywords or between the keyword and the sentence, and the number of letters located between the two keywords or between the keyword and the sentence.

At step 720, the control unit 320 may extract association weights between each representative attribute keyword and the subordinate keywords based on the degrees of association between the subordinate keywords. For example, for a subordinate keyword set corresponding to each representative attribute keyword, the control unit 320 may set a specific subordinate keyword within the subordinate keyword set and the representative attribute keyword so that the degree of association between the specific subordinate keyword within the subordinate keyword set and another subordinate keyword within the subordinate keyword set and an association weight between the specific subordinate keyword and the representative attribute keyword have a positive correlation therebetween.

For example, the higher the degrees of association between the subordinate keyword B1₁ of the representative attribute keyword A1 and other subordinate keywords B1₂ to B1₅₀ of the representative attribute keyword A1 are, the higher value the association weight between A1 and B1₁ may be set to. For example, the arithmetic mean (or sum) of the degrees of association between B1₁ and the other subordinate keywords B1₂ to B1₅₀ of A1 may become the association weight between B1₁ and A1. A geometric mean/harmonic mean may be used in place of a simple arithmetic mean. There may be used a truncated mean designed to calculate a mean with the two highest ones (examples) of the degrees of association between B1₁ and the other subordinate keywords B1₂ to B1₅₀ of A1 and the two lowest ones (examples) thereof excluded from the calculation. A median may be used in place of the arithmetic mean of the degrees of association.

According to some exemplary embodiments, “the frequency at which B1₁ and B1₂ appear in the same document” used to calculate the association weight of B1₁ for A1 does not vary simply depending on the number of documents in which B1₁ and B1₂ appear together (in which B1₁ and B1₂ appear in the same sentence, or in which B1₁ and B1₂ appear in close proximity to each other), but may be obtained by dividing the number of documents in which B1₁ and B1₂ appear together (in which B1₁ and B1₂ appear in the same sentence, or in which B1₁ and B1₂ appear in close proximity to each other) by the number of documents in which B1₁ appears and/or the number of documents in which B1₂ appears. In a similar manner, “the frequency at which B1₁ and B1₂ appear in the same document” may be set such that it has a positive correlation in connection with the number of documents in which B1₁ and B1₂ appear together (in which B1₁ and B1₂ appear in the same sentence, or in which B1₁ and B1₂ appear in close proximity to each other) and has a negative correlation in connection with the number of documents in which B1₁ appears and/or the number of documents in which B1₂ appears. This is a kind of normalization intended to prevent a frequently used word from simply having a high association weight in connection with the representative attribute keyword A1.

Referring back to FIG. 5, at step 540, the control unit 320 may extract the degrees of subordinate association between an object item and subordinate keywords from the first set documents.

It may be determined that subordinate keywords frequently appearing in the same document, the same sentence or a close sentence as an object keyword (for example “Taylor Swift”) representative of an object item in the first set documents are associated with the corresponding object item. The control unit 320 may collect documents in which the object keyword of the corresponding object item appears, and may extract the degree of subordinate association between each subordinate keyword and the object keyword based on the frequency at which they appear together within the documents. In particular, when a subordinate keyword appears in the same sentence as the object keyword, the control unit 320 may set the degree of association between the subordinate keyword and the object item to a higher value than when the subordinate keyword appears in a sentence different from that in which the object keyword appears.

The control unit 320 may set the degree of association between the subordinate keyword and the object item of the corresponding object keyword to a higher value in proportion to the proximity between a sentence in which the subordinate keyword appears and a sentence in which the object keyword appears. The proximity between two sentences may be determined based on, e.g., any one or more of the number of sentences located between the two sentences, the number of words located between the two sentences, the number of phases located between the two sentences, and the number of letters located between the two sentences.

The control unit 320 may set the degree of association between the subordinate keyword and the object item of the corresponding object keyword to a higher value in proportion to the proximity between a location at which the subordinate keyword appears and a location at which the object keyword appears. The proximity between the subordinate keyword and the object keyword may be determined based on, e.g., any one or more of the number of sentences located between the subordinate keyword and the object keyword, the number of words located between the subordinate keyword and the object keyword, the number of phases located between the subordinate keyword and the object keyword, and the number of letters located between the subordinate keyword and the object keyword.

At step 550, the control unit 320 may extract the degree of object-keyword association between the object item and the representative attribute keyword by using the degrees of subordinate association of step 540 and the association weights of step 530.

For example, the degree of object-keyword association between object item C and the representative attribute keyword A1 may be extracted using the degrees of subordinate association between C and the subordinate keywords (e.g., B1₁ to B1₅₀) of A1 and the association weights of the respectively subordinate keywords. For example, the degree of object-keyword association between the object item C and the representative attribute keyword A1 may be set to a higher value in proportion to the degrees of subordinate association between the object item C and the subordinate keywords B1₁ to B1₅₀.

When the degree of subordinate association with the object item C is higher for a subordinate keyword having a higher association weight in the relationship with A1, the degree of object-keyword association between the object C and the representative attribute keyword A1 may be set to a higher value for a subordinate keyword having a lower association weight than a case having a higher degree of subordinate association. For example, the degree of subordinate association of a keyword B1₁ having a higher association weight is higher in table 1 than in table 2, and thus the degree of object-keyword association between the object C and the representative attribute keyword A1 may be set to a higher value in table 1 than in table 2.

TABLE 1

| | Association weight in | Degree of subordinate |
|---|---|---|
| | connection with A1 | association with C |
| B1₁ | 0.5 | 0.5 |
| B1₂ | 0.2 | 0.2 |

TABLE 2

| | Association weight in | Degree of subordinate |
|---|---|---|
| | connection with A1 | association with C |
| B1₁ | 0.2 | 0.5 |
| B1₂ | 0.5 | 0.2 |

According to an exemplary embodiment, the degree of object-keyword association between the object C and the representative attribute keyword A1 may be obtained based on (or using) the sum of values obtained by multiplying association weights and the degrees of subordinate association corresponding to the individual subordinate keywords. In table 1, 0.5×0.5+0.2×0.2=0.29, and in table 2, 0.2×0.5+0.5×0.2=0.20. Accordingly, the degree of object-keyword association between the object C and the representative attribute keyword A1 may be set to a higher value in table 1 than in table 2.

The above-described method of calculating the degree of object-keyword association is merely an example. As long as the degree of subordinate association in connection with C obtained at step 540 and the association weight in connection with A1 obtained at step 530 have a positive correlation with the degree of object-keyword association between C and A1, another method may be used.

Thereafter, when the communication unit 310 receives a request for the provision of information associated with the specific representative attribute keyword, the control unit 320 may provide a result item via the communication unit 310 based on the degree of object-keyword association extracted at step 550. For example, when receiving a request for the provision of information including any one representative attribute keyword, the control unit 320 may provide information about object items in descending order of the degree of object-keyword association in the relationship with the corresponding representative attribute keyword.

In another exemplary embodiment, when receiving a request for the provision of information including two or more representative attribute keywords and corresponding weights, the control unit 320 may provide information about object items in descending order of the sum (or mean) of values obtained by multiplying the degrees of object-keyword association with the representative attribute keywords included in the request for the provision of information by weights (or adding weights to the degrees of object-keyword association) for each object item.

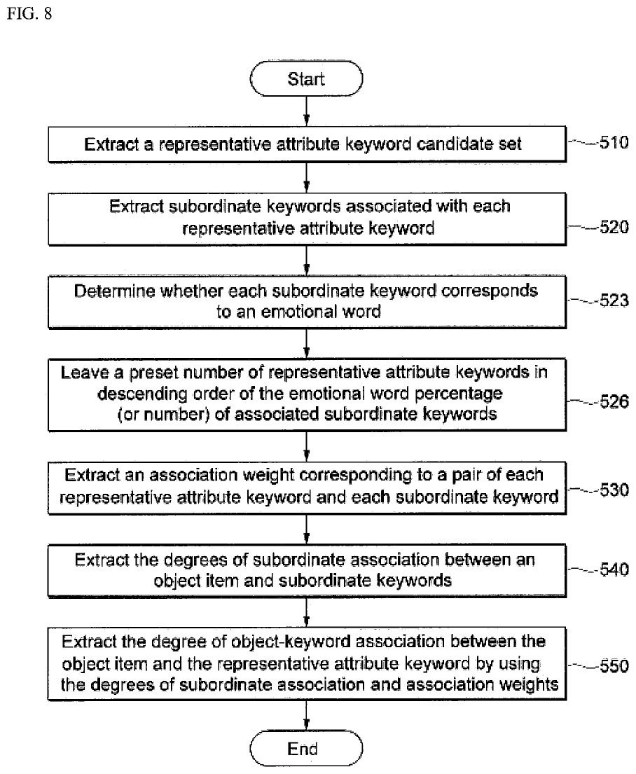

FIG. 8 is a flowchart of a process of providing information according to another exemplary embodiment of the present disclosure.

The exemplary embodiment of FIG. 8 further includes two steps 523 and 526 between steps 520 and 530 in addition to processes identical to those of the exemplary embodiment of FIG. 5. In this case, redundant descriptions will be omitted, and only steps 523 and 526 will be described.

At step 523, the control unit 320 determines whether each of the subordinate keywords extracted at step 520 corresponds to an emotional word. For this purpose, the storage unit 330 or external server may hold an emotional word dictionary. The emotional word dictionary is a tool for determining whether or not a word (keyword) is an emotional word, and may hold, e.g., an emotional word list. It may be determined that a keyword included in the emotional word list is an emotional word and a keyword not included in the emotional word list is not an emotional word. However, these determinations are based on dictionary meanings, and may not reflect the use of words by the public, which varies over time. Accordingly, the control unit 320 determines whether to use a representative attribute keyword based on whether or not subordinate keywords associated with the representative attribute keyword are emotional words without determining whether or not the representative attribute keyword itself is an emotional word.

In another exemplary embodiment, the control unit 320 may add another word, having a high degree of association (equal to or larger than a preset value) with a preset or larger number of words registered in the emotional word dictionary as emotional words, to the emotional word dictionary.

At step 526, the control unit 320 may leave a preset number of representative attribute keywords in a representative attribute keyword candidate set in descending order of the emotional word percentage (or number) of associated subordinate keywords, and may eliminate the remainder. Through this process, a keyword distant from an emotional word may be prevented from being treated as an emotional word.

Referring back to FIG. 9, at step 920, the control unit 320 stores the degree of basic reserved word-keyword association corresponding to each reserved word-representative attribute keyword pair in the storage unit 330.

Reserved words may include expressions which can be presented by the weights of representative attribute keywords. For example, “boring” may be a reserved word, and “pretty” may be a reserved word.

Representative attribute keywords each having a high degree of basic reserved word-keyword association in connection with the reserved word “boring” may include representative attribute keywords related to the resolution of a boring situation, such as “interesting,” “exciting,” “time-killing,” etc.

Representative attribute keywords having a high degree of basic reserved word-keyword association in connection with the reserved word “pretty” may include representative attribute keywords similar to “pretty” and describing “pretty,” such as “beautiful,” “cute,” “attractive,” etc.

For example, the process of step 920 may be performed by input of an administrator, or by receiving the degree of basic reserved word-keyword association, determined by an external system, via a network or storage medium. According to another exemplary embodiment, the process of step 920 may be performed by analyzing collectable documents, such as Internet information, SNS information, news, etc., and using a method similar to the processes of FIGS. 5 to 8. Furthermore, the process of step 920 may include a process of reflecting the feedback of a user, as will be described later.

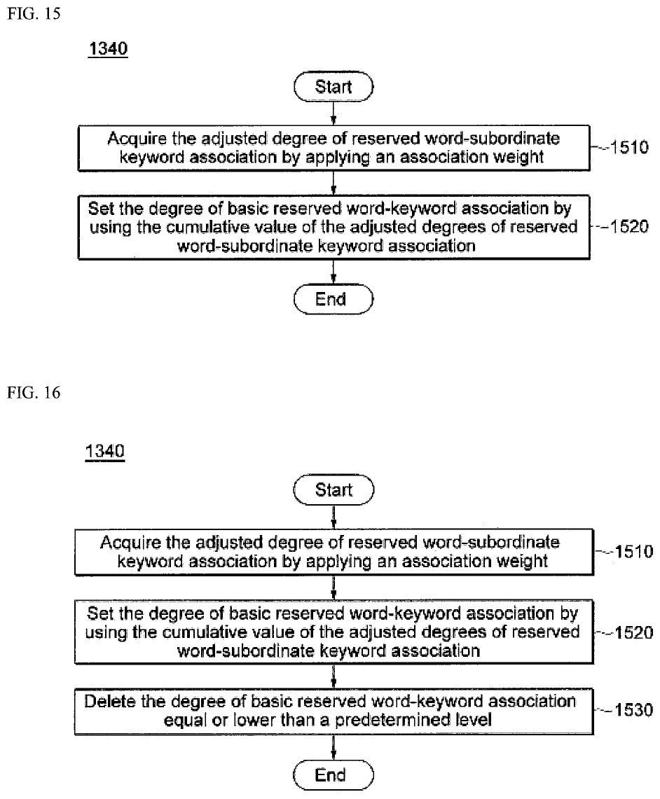

The process of step 920 may be performed using a method which will be described later with reference to any one of FIGS. 15 to 17.

FIG. 11 shows an example of the degrees of basic reserved word-keyword association according to an exemplary embodiment of the present disclosure.

In the exemplary embodiment of FIG. 11, reserved words are all q (C₁ to C_{q}) in number, and representative attribute keywords are all n (k₁ to kₙ) in number.

For example, the degree of basic reserved word-keyword association between the reserved word C₅ and the representative attribute keyword k₃ is v_{3,5}.

At step 930, the communication unit 310 receives and acquires a received reserved word from the terminal 200, and transfers the received reserved word to the control unit 320.

A received reserved word is a reserved word received by the terminal 200 from a search user. The terminal 200 may convert a voice input into an electrical signal (a voice signal), and may transfer the voice signal to the information provision apparatus 300. The control unit 320 of the information provision apparatus 300 may analyze the voice signal, may convert the voice signal into a text, and may match the text to a reserved word. Furthermore, the control unit 320 may analyze the intonation, pitch, tempo, respiration state, etc. of a voice by analyzing the voice signal, and may use analysis results as contextual information.

According to another exemplary embodiment, the terminal 200 may convert the voice input into a text, and may transfer the text to the information provision apparatus 300. The terminal 200 may analyze the intonation, pitch, tempo, respiration state of a voice, etc., and may transfer analysis information to the information provision apparatus 300. The information provision apparatus 300 may use the analysis information as a type of contextual information.

At step 940, the control unit 320 may acquire the degree of reserved word-object association corresponding to a pair of the received reserved word and each object item by using the degree of object-keyword association and the degree of basic reserved word-keyword association.

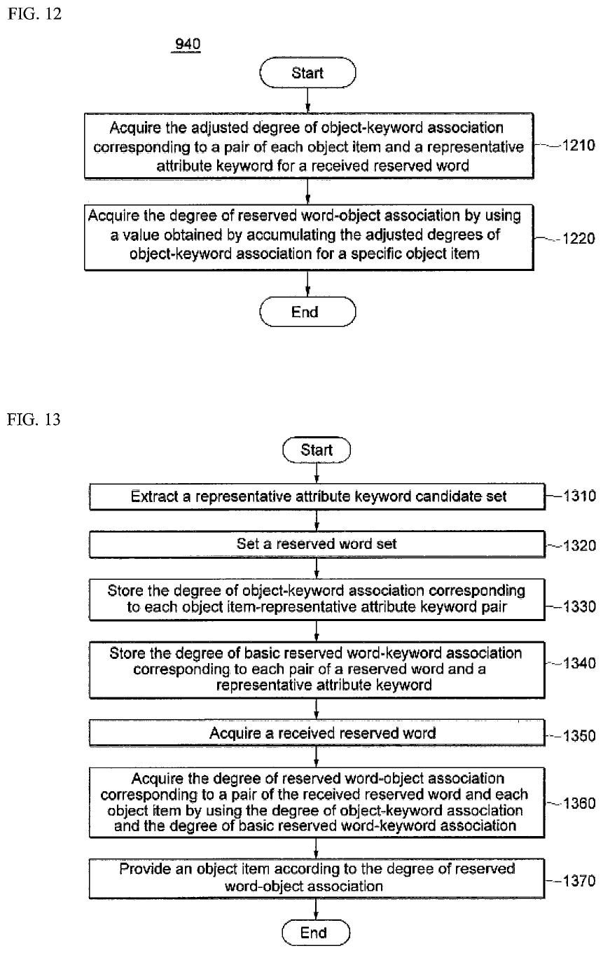

FIG. 12 is a detailed flowchart of step 940 according to an exemplary embodiment of the present disclosure.

Referring to FIG. 12, at step 1210, the control unit 320 acquires the adjusted degree of object-keyword association corresponding to a pair of each object item and the representative attribute keyword for the received reserved word.

According to an exemplary embodiment, for a pair of each object item and a representative attribute keyword, the control unit 320 may acquire the adjusted degree of object-keyword association corresponding to a pair of each object item and a representative attribute keyword for the received reserved word by applying the degree of basic reserved word-keyword association corresponding to a pair of the received reserved word and the representative attribute keyword to the degree of object-keyword association corresponding to the pair of the object item and the representative attribute keyword.

In particular, for a pair of each object item and a representative attribute keyword, the control unit 320 may acquire the adjusted degree of object-keyword association corresponding to a pair of each object item and a representative attribute keyword for the received reserved word by using a value obtained by multiplying the degree of object-keyword association corresponding to the pair of the object item and the representative attribute keyword by the degree of basic reserved word-keyword association corresponding to a pair of the received reserved word and the representative attribute keyword.

Furthermore, for a pair of each object item and a representative attribute keyword, the control unit 320 may set the adjusted degree of object-keyword association corresponding to a pair of each object item and a representative attribute keyword for the received reserved word so that the adjusted degree of object-keyword association has a positive correlation with the degree of object-keyword association corresponding to the pair of the object item and the representative attribute keyword and has a positive correlation with the degree of basic reserved word-keyword association corresponding to a pair of the received reserved word and the representative attribute keyword.

In the present disclosure, it is assumed that the degree of object-keyword association, the degree of basic reserved word-keyword association, the adjusted degree of object-keyword association, the degree of basic reserved word-subordinate keyword association, and other values each representative of the degree of association are values which are each representative of a closer correlation in proportion to the size of the value. In another exemplary embodiment, in the case where the value of a type of the degree of association is representative of a closer correlation in inverse proportion to the size of the value and the value of another type of the degree of association value is representative of a closer correlation in proportion to the size of the value, a positive correlation and a negative correlation are appropriately replaced with each other and then used in accordance with the case.

For example, in order to acquire the adjusted degree of object-keyword association corresponding to a pair of object item i₄ and representative attribute keyword k₃ when the received reserved word is C₂, the control unit 320 may acquire the adjusted degree of object-keyword association by applying the degree of basic reserved word-keyword association v_{3,4} corresponding to a pair of the received reserved word C₂ and the representative attribute keyword k₃ to the degree of object association w_{4,3} corresponding to the pair of the object item i₄ and the representative attribute keyword k₃.

In particular, a method of applying the degree of association may be a method of multiplying the degree of object association and the degree of basic reserved word-keyword association. For example, in order to acquire the adjusted degree of object-keyword association corresponding to a pair of object item i₄ and representative attribute keyword k₃ when the received reserved word is C₂, the control unit 320 may acquire the adjusted degree of object-keyword association by using the value (w_{4,3}×v_{3,2}) obtained by multiplying the degree of object association w_{4,3} corresponding to the pair of the object item i₄ and the representative attribute keyword k₃ and the degree of basic reserved word-keyword association v_{3,2} corresponding to a pair of the received reserved word C₂ and the representative attribute keyword k₃. In another exemplary embodiment, the control unit 320 may acquire the adjusted degree of object-keyword association by using function f(w_{4,3}, v_{3,2}) based on another calculation/utilization method adapted to allow the adjusted degree of object-keyword association to have a positive correlation with w_{4,3} and v_{3,2} in place of the multiplication. Furthermore, both a method of using (w_{4,3}×v_{3,2}) as the adjusted degree of object-keyword association and a method of applying another factor-based correction to (w_{4,3}×v_{3,2}) and then using a resulting value as the adjusted degree of object-keyword association may be used.

At step 1220, the control unit 320 may acquire the degree of reserved word-object association by using a value obtained by accumulating the adjusted degrees of object-keyword association for a specific object item. For example, the control unit 320 may set the degree of reserved word-object association corresponding to a pair of the received reserved word and the specific object item so that the degree of reserved word-object association has a positive correlation with the cumulative value of the adjusted degrees of object-keyword association for a specific object item. The degree of reserved word-object association corresponding to a pair of object item i₄ and received reserved word C₂ may be acquired using, e.g., Σⱼ₌₁ⁿ f(w_{4,j}, v_{j,2}). f(w_{4,j}, v_{j,2}) is the adjusted degree of object-keyword association corresponding to object item i₄, received reserved word C₂, and keyword kⱼ.

For example, the degree of reserved word-object association corresponding to a pair of object item i₄ and received reserved word C₂ may be Σⱼ₌₁ⁿ(w_{4,j}×v_{j,2})=(w_{4,1}×v_{1,2})+(w_{4,2}×v_{2,2})+ ⋅ ⋅ ⋅ +(w_{4,n}×v_{n,2}). In another example, the degree of reserved word-object association corresponding to a pair of object item i₄ and received reserved word C₂ may be a value obtained by applying another factor-based correction to Σⱼ₌₁ⁿ(w_{4,j}, v_{j,2}).

Referring back to FIG. 9, at step 950, the control unit 320 may provide an object item according to the degree of reserved word-object association corresponding to the received reserved word. For example, when the degrees of reserved word-object association corresponding to received reserved word C₂ are as shown in table 3, the control unit 320 may provide object items in the order shown in table 4.

TABLE 3

| | Degree of reserved word-object |
|---|---|
| Object item | association with received reserved word |
| i₁ | 0.23 |
| i₂ | 0.33 |
| i₃ | 0.99 |
| i₄ | 0.84 |

TABLE 4

| | | Degree of reserved word- |
|---|---|---|
| | | object association with |
| Order | Object item | received reserved word |
| 1 | i3 | 0.99 |
| 2 | i4 | 0.84 |
| 3 | i2 | 0.33 |
| 4 | i1 | 0.23 |

In other words, the control unit 320 may provide object items in descending order of the degree of reserved word-object association corresponding to the received reserved word. The terminal 200 having received the object items may provide information about object item i₃ to a user via the display unit 220. The terminal 200 may provide information about another object item at a lower order position when necessary. The terminal 200 may provide information about object item i3 to a user by voice through a speaker in place of the display unit 220.

FIG. 13 is a flowchart of a process of providing information according another exemplary embodiment of the present disclosure.

The processes of FIGS. 13 to 17 may be performed by using some of the processes of FIGS. 5 to 12 or modifying some of the processes of FIGS. 5 to 12. When the processes of FIGS. 13 to 17 are described, descriptions of FIGS. 5 to 12 may be quoted when necessary.

Referring to FIG. 13, at step 1310, the control unit 320 extracts a representative attribute keyword candidate set from first set documents. For example, the control unit 320 may collect keywords, frequently appearing in the documents of the first set documents corresponding to a field of interest, as a representative attribute keyword candidate set. The process of step 1310 may be performed in a manner identical or similar to, e.g., that of the process of step 510 of FIG. 5. The process of step 1310 may be performed in a manner identical and similar to that of the process of FIG. 6. The description of the process of FIG. 6 is not repeated.

At step 1320, the control unit 320 sets a reserved word set. For example, an administrator may set a reserved word set through manual input. According to a modified exemplary embodiment, the control unit 320 may set word phrases/passages, etc. suitable for reserved words as reserved word candidates, and may provide an interface configured to allow one or more of the reserved word candidates as reserved words.

FIG. 18 is a detailed flowchart of step 1320 according to a modified exemplary embodiment of the present disclosure.

At step 1810, the control unit 320 acquires the appearing frequency of one linguistic unit or two or more consecutive linguistic units within the document set. In this case, the document set may be the same as or different from the document set used in the process of step 510 of FIG. 5.

The linguistic unit may be, e.g., any one of a word phrase, a word, a morpheme, a syllable, and a letter. Other units defined to segment a sentence based on various criteria may be used as the linguistic unit in the present exemplary embodiment.

Before step 1810, the control unit 320 may segment documents, included in the individual documents of the document set, into word phrase units and store the word phrase units in the form of an array or list. In an exemplary embodiment, the control unit 320 may delete insignificant words, e.g., some postpositional particles and demonstrative adjective, such as “ [symbol] ,” “ [symbol] ,” etc., in Korean, and other words not requiring analysis from each word phrase, or may remove from the array or list. Furthermore, in an exemplary embodiment, when a word phrase is composed of one word, the control unit 320 may convert the corresponding word into a basic or preset form.

According to a modified exemplary embodiment, before step 1810, the control unit 320 may segment documents, included in the individual documents of the document set, into word units and store the word units in the form of an array or list. In an exemplary embodiment, the control unit 320 may convert each word into a basic (or preset) form. In an exemplary embodiment, the control unit 320 may remove insignificant words, e.g., some postpositional particles and demonstrative adjective, such as “O|” [symbol] ” etc., in Korean, and other words not requiring analysis from the array or list.

There may be possible a modified exemplary embodiment in which the control unit 320 segments documents into morpheme units, syllable units, or letter units.

In the following exemplary embodiment, for the sake of convenience, it is assumed that the control unit 320 segments the documents into word phrase units and the word phrases become linguistic units.

A single linguistic unit may become a reserved word. According to a modified exemplary embodiment, two or more consecutive linguistic units also become a reserved word. For example, “neat” (a single linguistic unit) may become a reserved word, “nicely atmospheric” (two consecutive linguistic units) may become a reserved word. However, two or more consecutive linguistic units appear less frequently than a single linguistic unit. Accordingly, in an exemplary embodiment, a weight or an additional score may be given to two or more consecutive linguistic units upon the selection of reserved words so that the two or more consecutive linguistic units can be selected as a reserved word. According to a modified exemplary embodiment, upon the selection of reserved words, a reference value for the selection of a reserved word may be set to a lenient value for two or more consecutive linguistic unit. For example, in the case where a single linguistic unit may be recommended as a reserved word candidate only when it appears at least “a” times, settings may be made such that two consecutive linguistic units may be recommended as a reserved word candidate even when they appear “b” times considerably less than “a” times and such that three consecutive linguistic units may be recommended as a reserved word candidate even when they appear “c” times less than “b” times. In the following, two or more consecutive linguistic units are called consecutive linguistic units.

Furthermore, in the case where consecutive linguistic units are recommended/selected as a reserved word, it is included in a linguistic unit included in the reserved word candidate or in the reserved word candidate itself, and consecutive linguistic units shorter than the reserved word candidate may be prevented from being recommended as reserved words, or a deduction in a score may be made during the calculation of a score used to recommend the units as a reserved word. The reason for this is to prevent a plurality of similar reserved words from being selected or recommended. In the following, for the sake of simplicity of description, although descriptions of consecutive linguistic units will be omitted, descriptions of a single linguistic unit may be applied to consecutive linguistic units in an identical or similar manner.

At step 1810, the appearing frequency of a linguistic unit may be, e.g., the number of documents in which the corresponding linguistic unit appears. Even when a corresponding linguistic unit appears in a single document a plurality of times, only an appearing frequency of 1 is recognized. In contrast, according to another exemplary embodiment, in the case where a corresponding linguistic unit appears in a single document a plurality of times, the number of times may be all recognized as an appearing frequency, and the appearing frequency may become the appearing frequency of the linguistic unit.

According to still another exemplary embodiment, in the case where a corresponding linguistic unit appears in a single document two or more times, second and later appearances may be evaluated as being lower than a first appearance. Furthermore, in the case where the appearance of a corresponding linguistic unit is repeated in a single document, later appearances may be evaluated as being lower. Although a score increases as the number of appearances increases, the gradient of scores gradually becomes gentle. For example, an appearance frequency to the power of 1/r (where r is a real number larger than 1) may be used as the appearance score of a corresponding linguistic unit in a corresponding document. For example, (the log value of an appearing frequency)+1 (where when the appearing frequency is 0, a corresponding appearance score is 0) or the like may be used. Furthermore, the appearance score of a linguistic unit in a single document may be limited to a value equal to or smaller than a preset upper limit value. A value obtained by accumulating the appearance scores of a corresponding linguistic unit for all documents may become an appearance score based on the appearing frequencies of the corresponding linguistic unit. Furthermore, this appearance score may be used at step 1830.

In the following, for the sake of convenience, the following description will be given on the assumption that the appearing frequency of a linguistic unit is the number of documents in which the corresponding linguistic unit appears.

At step 1820, the control unit 320 acquires the frequency at which an emotional word is located within a preset distance from a linguistic unit. The distance between the linguistic unit and the emotional word may be determined based on, e.g., any one or more of the number of words located between the linguistic unit and the emotional word, the number of word phrases located between the linguistic unit and the emotional word, and the number of letters located between the linguistic unit and the emotional word.

Furthermore, when a linguistic unit and an emotional word belong to different sentences; the control unit 320 may determine that the emotional word is not located within the preset distance from the linguistic unit regardless of the number of words, word phrases and/or letters located between the linguistic unit and the emotional word. According to another modified exemplary embodiment, when a linguistic unit and an emotional word belong to different sentences, the control unit 320 may calculate the distance therebetween by adding a predetermined numerical value to a calculated distance without taking into account the sentences. The reason for this is that when a linguistic unit and an emotional word belong to different sentences, probability that they have no correlation is stronger, and thus it is preferable that the distance therebetween is evaluated as being longer than the number of words, word phrases and/or letters located between the linguistic unit and the emotional word.

Whether a specific word (a word phrase) is an emotional word may be determined by referring to the previously registered emotional word dictionary.

The frequency at which an emotional word is located within a predetermined distance from a linguistic unit may be, e.g., the number of documents in which the corresponding linguistic unit and the corresponding emotional word are located together within a predetermined distance. Even when a corresponding linguistic unit and a corresponding emotional word appear within the predetermined distance a plurality of times in a single document, only an appearing frequency of 1 is recognized. According to another exemplary embodiment, when an emotional word is located within a predetermined distance from a plurality of linguistic units, all cases where the emotional word is located within the predetermined distance from the individual linguistic units may be recognized as a frequency. In the following, a linguistic unit located within the predetermined distance from an emotional word is called an emotional word location linguistic unit.

According to still another exemplary embodiment, in the case where an emotional word location linguistic unit appears in a single document two or more times, second and later appearances may be evaluated as being lower than a first appearance. Furthermore, in the case where the appearance of a corresponding emotional word location linguistic unit is repeated in a single document, later appearances may be evaluated as being lower. Although a score increases as the number of appearances increases, the gradient of scores gradually becomes gentle. For example, an appearance frequency to the power of 1/r (where r is a real number larger than 1) may be used as the appearance score of a corresponding emotional word location linguistic unit in a corresponding document. For example, (the log value of an appearing frequency)+1 (where when the appearing frequency is 0, a corresponding appearance score is 0) or the like may be used. Furthermore, the appearance score of an emotional word location linguistic unit in a single document may be limited to a value equal to or smaller than a preset upper limit value. A value obtained by accumulating the appearance scores of a corresponding emotional word location linguistic unit for all documents may become an appearance score based on the appearing frequencies of the corresponding emotional word location linguistic unit. Furthermore, this appearance score may be used at step 1830.

Furthermore, according to another exemplary embodiment, a higher appearance score may be recognized in proportion to the number of emotional words located within a predetermined distance from one linguistic unit. Furthermore, when an emotional word is located within a shorter distance from one linguistic unit, a higher appearance score may be recognized. Furthermore, only when preset two or more emotional words are located within a predetermined distance from one linguistic unit may an appearance score (an appearing frequency) be recognized.

For the sake of convenience, the following description will be given on the assumption that the appearing frequency of an emotional word location linguistic unit is the number of documents in which an emotional word appears within a preset distance from a corresponding linguistic unit.

At step 1830, the control unit 320 selects a reserved word candidate by taking into account the appearing frequency of a corresponding linguistic unit and the frequency at which an emotional word is located within a predetermined distance from the linguistic unit.

For example, the control unit 320 obtains an emotional word score by multiplying the appearing frequency of a corresponding linguistic unit and the frequency at which an emotional word is located within a predetermined distance from the linguistic unit (or by using a calculation method which has a positive correlation for the two variables). Furthermore, a preset number of reserved word candidates may be set in descending order of the score. Alternatively, linguistic units corresponding to a preset score or more may be set as reserved word candidates.

TABLE 5

| | Appearing | Emotional word | |
|---|---|---|---|
| Linguistic unit | frequency | location frequency | Score |
| First linguistic unit | 3003 | 1122 | 3369366 |
| Second linguistic unit | 2001 | 1820 | 3641820 |
| Third linguistic unit | 3121 | 1300 | 4057300 |
| Fourth linguistic unit | 200 | 110 | 22000 |

In the example of table 5, the linguistic units may become reserved word candidates in order of the third linguistic unit->the second linguistic unit->the first linguistic unit->the fourth linguistic unit. When the control unit 320 recommends two reserved word candidates, the third linguistic unit and the second linguistic unit will be recommended. When the control unit 320 recommends linguistic units equal to or larger than a perfect score of 300 as reserved word candidates, the third linguistic unit, the second linguistic unit, and the first linguistic unit will be recommended as reserved word candidates in order thereof.

According to another exemplary embodiment, the control unit 320 may extract a first number of linguistic units in order of the appearing frequencies of the linguistic units, and may then extract a predetermined number of reserved word candidates in descending order based on the frequency at which an emotional word appears within a predetermined distance from the extracted linguistic units (or an emotional word score). In the example of table 5, when three linguistic units are extracted in descending order of their appearing frequency, the first to third linguistic units may be extracted. Based on the appearing frequencies of emotional words, reserved word candidates may be recommended in order of the second linguistic unit, the third linguistic unit, and the first linguistic unit.

Furthermore, according to another exemplary embodiment, the control unit 320 may extract a first number of linguistic units in descending order of the appearing frequencies of the linguistic units, and may then extract a first number of reserved word candidate (where the second number is less than the first number) in descending order based on the frequency at which an emotional word appears within a predetermined distance from the extracted linguistic units (or an emotional word score). In the example of table 5, when three linguistic units are extracted in descending order of their appearing frequency, the first to third linguistic units may be extracted. When two linguistic units are extracted based on an emotional word appearing frequency, reserved word candidates may be recommended in order of the second linguistic unit and the third linguistic unit.

Using another method similar or slightly different from the above-described method, the control unit 320 may set a score for the selection of reserved word candidates so that the score for the selection of reserved word candidates has a positive correlation with the appearing frequencies of linguistic units at step 1810 and also has a positive correlation with the appearing frequencies of linguistic units from which an emotional word is located within the preset distance at step 1820, and may recommend reserved word candidates by using the score.

Furthermore, the control unit 320 may perform processing such that a linguistic unit already included in a reserved word set can be prevented from being recommended as a reserved word candidate. Furthermore, the control unit 320 may perform processing such that a linguistic unit substantially identical to a reserved word included in the reserved word set can be prevented from being added to reserved word candidates.

At step 1840, the information provision apparatus 300 provides the terminal 200 with interface information adapted to generate a reserved word selection interface including reserved word candidate information. The interface information may be, e.g., a document in an html form. According to another exemplary embodiment, the interface information may include only dynamic information (recommended reserved word candidates, etc.) required to generate the interface, and the terminal 200 may provide a page including the interface to a user in such a manner as to incorporate the dynamic information into a page form stored in the terminal 200 in advance.

The control unit 320 may generate page information adapted to generate the page including the reserved word selection interface inclusive of the reserved word candidate information, and the communication unit 310 may provide the page information to the terminal 200. The terminal 200 may display the page including the corresponding interface to a user through rendering. According to a modified exemplary embodiment, an interface based on sound or an interface based on technology known currently or to be known in the future may be provided in place of the interface included in the visual page. For the sake of convenience, the following description will be given on the assumption that the interface included in the visual page is provided.

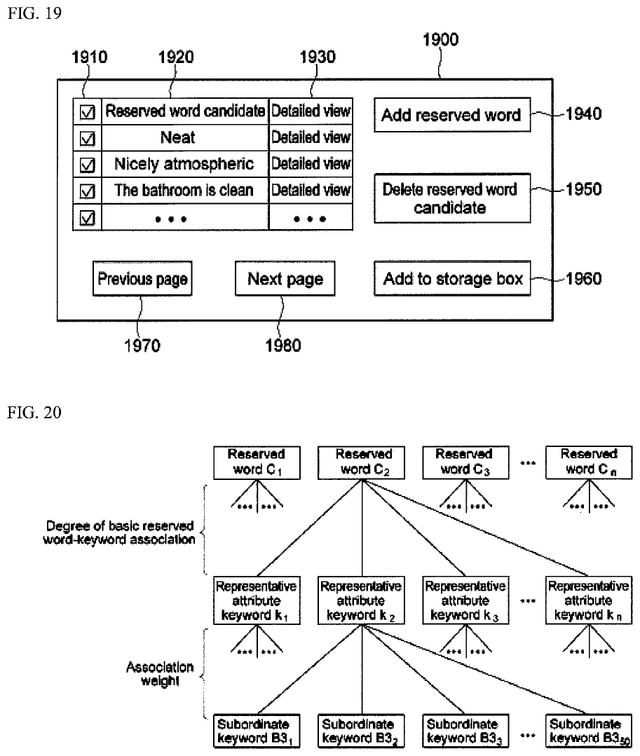

FIG. 19 is an example of an interface 1900 generated based on the interface information provided at step 1840.

Referring to FIG. 19, the interface 1900 includes a table, including a check box column 1910, a reserved word candidate column 1920, and a detailed view column 1930. Furthermore, the interface 1900 may include a reserved word addition button 1940, a candidate deletion button 1950, and an add-to-storage box button 1960. A user may select at least one desired reserved word candidate on the check box column 1910, and may process the reserved word candidate by selecting any one of the reserved word addition button 1940, the candidate deletion button 1950, and the add-to-storage box button 1960. Once the any one of the buttons has been selected, the terminal 200 may transfer input information, obtained by converting the input of the user, to the information provision apparatus 300.

The information provision apparatus 300 may process the reserved word candidate according to the input information received from the terminal 200. For example, when a user selects the check boxes 1910 of some reserved word candidates (hereinafter referred to as the “selected candidates”) and also selects the reserved word addition button 1940, the control unit 320 of the information provision apparatus 300 having related input information may add the selected candidates to a reserved word set and also delete the selected candidates from a reserved word candidate set. The control unit 320 performs control such that the language units included in the reserved word set and linguistic units substantially identical to the language units included in the reserved word set can be prevented from being recommended as reserved word candidates upon the future recommendation of reserved word candidates.

According to another example, when a user selects the check boxes 1910 of some reserved word candidates and also selects the reserved word candidate deletion button 1950, the control unit 320 of the information provision apparatus 300 having received related input information may add the selected candidates to a reserved word exclusion set and delete the selected candidates from the reserved word candidate set. The control unit 320 performs control such that the language units included in the reserved word exclusion set and linguistic units substantially identical to the language units included in the reserved word exclusion set can be prevented from being recommended as reserved word candidates upon the future recommendation of reserved word candidates.

Furthermore, according to another example, when a user selects the check boxes 1910 of some reserved word candidates and also selects the add-to-storage box button 1960, the control unit 320 of the information provision apparatus 300 having received related input information may add the selected candidates to a reserved word candidate storage set and delete the selected candidates from the reserved word candidate set. The control unit 320 performs control such that the language units included in the reserved word candidate storage set and linguistic units substantially identical to the language units included in the reserved word candidate storage set can be prevented from being recommended as reserved word candidates upon the future recommendation of reserved word candidates.

Another interface similar to the buttons or another interface capable of replacing the functions of the buttons may be used in place of the buttons 1940, 1950 and 1960.

Furthermore, the control unit 320 may provide an interface adapted to delete part of reserved words from the reserved word set. The control unit 320 may provide an interface adapted to delete a linguistic unit from the reserved word exclusion set such that part of the linguistic units in the reserved word exclusion set are prevented from being excluded from recommendation. The control unit 320 may provide the linguistic unit of the reserved word candidate storage set in the form of a list interface similar to that of FIG. 19, and may enable a user to add part of the linguistic units of the reserved word candidate storage set as a reserved word via the list interface. Furthermore, a user may include part of the linguistic units of the reserved word candidate storage set in the reserved word exclusion set and delete the part of the linguistic units from the reserved word candidate storage set via the list interface. In this case, the corresponding linguistic unit is not provided via the list interface of the reserved word candidate storage set any longer, and is not recommended as a reserved word candidate via the interface 1900 of FIG. 19 any longer. Furthermore, a user may simply delete part of the linguistic units of the reserved word candidate storage set from the reserved word candidate storage set via the list interface. In this case, the corresponding linguistic unit is not provided via the list interface of the reserved word candidate storage set any longer, but may be recommended as a reserved word candidate via the interface 1900 of FIG. 19.

Furthermore, the interface 1900 may include a previous page button 1970 and/or a subsequent page button 1980 for switching between pages in preparation for a case where reserved word candidates cannot be all displayed within a single page. The previous page button 1970 and/or the subsequent page button 1980 may be selectively provided depending on the number of actual candidates and a current page location. Furthermore, there may be provided an interface adapted to be extendable through scrolling in place of the previous page button 1970 and/or the subsequent page button 1980. In some interfaces, only a table including the items 1910, 1920 and 1930 may be scrolled, and the buttons 1940, 1950, 1960, 1970 and 1980 may be excluded from scrolling.

A user may refer to a background for the recommendation of a reserved word candidate or related information in detail by selecting the detailed view 1930. An interface which is provided by the control unit 320 when the detailed view 1930 is selected may include an interface adapted to add information about a corresponding reserved word candidate and the corresponding reserved word candidate as a reserved word, to the reserved word candidate storage set, or to the reserved word exclusion set.

The control unit 320 may provide an interface configured to manage reserved word candidates to a user via the terminal 200.

Referring back to FIG. 18, at step 1850, the control unit 320 may add a selected reserved word candidate to the reserved word set in response to an input adapted to select the reserved word.

Referring back to FIG. 13, at step 1330, the control unit 320 stores the degree of object-keyword association corresponding to each object item-representative attribute keyword pair.

FIG. 10 shows an example of the stored degrees of object-keyword association according to an exemplary embodiment of the present disclosure.

In the exemplary embodiment of FIG. 10, object items are all in m (i₁ to iₘ) in number, and representative attribute keywords are all n (k₁ to kₙ) in number.

For example, the degree of object-keyword association between the object item i₅ and the representative attribute keyword k₃ is w_{5,3}.

The process of step 1330 may be performed according to, e.g., part of the exemplary embodiments of FIGS. 5 to 8, or a process similar or corresponding to the part. According to another exemplary embodiment, the process of step 1330 may be performed by the input of an administrator or by receiving the degree of object-keyword association, determined by an external system, via a network or storage medium.

Since the exemplary embodiments of FIGS. 5 to 8 have been described above, redundant descriptions will be omitted. However, the process of step 510 of FIGS. 5 and 8 is substantially the same as the process of step 1310 of FIG. 13. Accordingly, when the process of step 1330 is performed, the process of step 510 may not be performed again and the result of step 1310 may be reused even when the exemplary embodiments of FIGS. 5 to 8 are used.

At step 1340, the control unit 320 stores the degree of basic reserved word-keyword association corresponding to each pair of a reserved word and a representative attribute keyword in the storage unit 330 by using an association weight corresponding to a pair of the representative attribute keyword and a subordinate keyword and the degree of basic reserved word-subordinate keyword association corresponding to a pair of the reserved word and the subordinate keyword. The process of step 1340 may be performed according to, e.g., the input of an administrator or the exemplary embodiments of any one or more of FIGS. 15 to 17.

Before or during the process of step 1340, the subordinate keyword needs to be determined, the association weight corresponding to the pair of the representative attribute keyword and the subordinate keyword needs to be determined, and the degree of basic reserved word-subordinate keyword association corresponding to the pair of the reserved word and the subordinate keyword needs to be determined.

The subordinate keyword used in the process of step 1340 may be determined through the performance of step 520 during the process of step 1330. In this case, the subordinate keyword of step 520 may be used at step 1340. Unless the subordinate keyword is determined at step 1330, the subordinate keyword may be determined through step 520 of FIG. 5 and a process identical or similar to its previous process.

The association weight used in the process of step 1340 may be determined through the performance of step 530 during the process of step 1330. In this case, the association weight of step 530 may be used at step 1340. Unless the association weight is determined at step 1330, the association weight may be determined step 530 of FIG. 5 and a process identical or similar to its previous process.

The degree of basic reserved word-subordinate keyword association may be calculated by, e.g., taking into account the frequency at which the reserved word and the subordinate keyword appear in the same context or similar contexts.

In the following, in descriptions of FIGS. 15 to 17, an example of obtaining the degree of basic reserved word-keyword association v_{3,2} between reserved word C₂ and representative attribute keyword k₃ is described. For example, it is assumed that the subordinate keywords of the representative attribute keyword k₃ are B3₁ to B3₅₀. For the reserved word, the representative attribute keyword, and the degree of basic reserved word-keyword association, reference is made to the example described above with reference to FIG. 11. The degree of basic reserved word-subordinate keyword association corresponding to a pair of reserved word Cⱼ and subordinate keyword B_{gh} is represented by x_{j,h}. An association weight corresponding to a pair of the subordinate keyword B_{gh} and representative attribute keyword k_{g} is represented by y_{g,h}. The adjusted degree of reserved word-subordinate keyword association corresponding to the combination of reserved word Cⱼ, representative attribute keyword k_{g}, and subordinate keyword B_{gh} is represented by x_{j,g,h}.

FIG. 15 is a detailed flowchart of step 1340 according to a first exemplary embodiment of the present disclosure.

Referring to FIG. 15, at step 1510, the control unit 320 acquires the adjusted degree of reserved word-subordinate keyword association by applying the association weight to the degree of basic reserved word-subordinate keyword association.

At step 1510, for each reserved word-subordinate keyword pair, the control unit 320 may obtain the adjusted degree of reserved word-subordinate keyword association corresponding to the reserved word-subordinate keyword pair for the representative attribute keyword by applying an association weight corresponding to a subordinate keyword-representative attribute keyword pair to the degree of basic reserved word-subordinate keyword association corresponding to the reserved word-subordinate keyword pair.

For example, in order to acquire the adjusted degree of reserved word-subordinate keyword association between C₂ and B3₄ corresponding to a pair of subordinate keyword B3₄ and representative attribute keyword k₃ when a reserved word is C₂, the control unit 320 may obtain the adjusted degree of reserved word-subordinate keyword association x_{2,3,4} by applying association weight y_{3,4} corresponding to the pair of the subordinate keyword B3₄ and the representative attribute keyword k₃ to the degree of basic reserved word-subordinate keyword association x_{2,4} corresponding to a pair of the reserved word C₂ and the subordinate keyword B3₄.

In particular, a method of applying an association weight may be a method of multiplying the degree of basic reserved word-subordinate keyword association x_{2,4} by the association weight y_{3,4} corresponding to the pair of the subordinate keyword B3₄ and the representative attribute keyword k₃. For example, in order to acquire the adjusted degree of reserved word-subordinate keyword association x_{2,3,4} between C₂ and B3₄ corresponding to a pair of the subordinate keyword B3₄ and the representative attribute keyword k₃ when the reserved word is C₂, the control unit 320 may acquire the adjusted degree of reserved word-subordinate keyword association x_{2,3,4} by using value x_{2,4}×y_{3,4} obtained by multiplying the pair of the reserved word C₂ and the subordinate keyword B3₄ corresponding to the degree of basic reserved word-subordinate keyword association x_{2,4} by association weight y_{3,4} corresponding to the pair of the subordinate keyword B3₄ and the representative attribute keyword k₃. In another exemplary embodiment, the control unit 320 may acquire the adjusted degree of reserved word-subordinate keyword association x_{2,3,4} by using function f(x_{2,4},y_{3,4}) based on another calculation/utilization method adapted to allow the adjusted degree of reserved word-subordinate keyword association x_{2,3,4} to have a positive correlation with x_{2,4} and y_{3,4} in place of the multiplication. Furthermore, both a method of using (x_{2,4}×v_{3,4}) as the adjusted degree of reserved word-subordinate keyword association x_{2,3,4} and a method of applying another factor-based correction to (x_{2,4}×v_{3,4}) and then using a resulting value as the adjusted degree of reserved word-subordinate keyword association x_{2,3,4} may be used.

At step 1520, the control unit 320 may set the degree of basic reserved word-keyword association by using the cumulative value of the adjusted degrees of reserved word-subordinate keyword association x_{2,3,f} between the reserved word C₂ and the representative attribute keyword k₃. In other words, the degree of basic reserved word-keyword association between the reserved word C₂ and the representative attribute keyword k₃ may be Σ_{f=1}⁵⁰x_{2,3,f}. In other words, the degree of basic reserved word-keyword association between the reserved word C₂ and the representative attribute keyword k₃ may be obtained by obtaining the degrees of basic reserved word-subordinate keyword association x_{2,f} with reserved word C₂ for subordinate keywords B3₁ to B3₅₀, obtaining x_{2,3,f} by incorporating an association weight y_{3,f} for the corresponding subordinate keyword to each of the degrees of basic reserved word-subordinate keyword association x_{2,f}, and then accumulating x_{2,3,f}. According to another exemplary embodiment, the degree of basic reserved word-keyword association between the reserved word C₂ and the representative attribute keyword k₃ may be a value obtained by applying another factor-based correction to Σ_{f=1}⁵⁰x_{2,3,f}. According to another exemplary embodiment, the degree of basic reserved word-keyword association between the reserved word C₂ and the representative attribute keyword k₃ may be a value having a positive correlation with Σ_{f=1}⁵⁰x_{2,3,f}. In this case, it is assumed that subordinate keywords connected to one representative attribute keyword are 50 in number. However, when the number of subordinate keywords connected to a representative attribute keyword varies, the cumulative range off may become a different value, other than 50, in the formula.

FIG. 16 is a detailed flowchart of step 1340 according to another exemplary embodiment of the present disclosure. Since the processes of steps 1510 and 1520 of FIG. 16 are the same as the processes described with reference to FIG. 15, redundant descriptions will be omitted.

Referring to FIG. 16, at step 1530, the control unit 320 may delete the degree of basic reserved word-keyword association for at least one representative keyword, for which the degree of basic reserved word-keyword association for a pair of the reserved word and the corresponding representative keyword is equal or lower than the reference degree of basic reserved word-keyword association, among representative keywords corresponding to a specific reserved word. Representative keywords corresponding to a specific reserved word refer to keywords for which the degrees of basic reserved word-keyword association have been set in the relationship with the specific reserved word. The reference degree of basic reserved word-keyword association may be set in advance. According to another exemplary embodiment, the reference degree of basic reserved word-keyword association may be set using the average value of the degrees of basic reserved word-keyword association corresponding to the specific reserved word, or may be set using the degree of basic reserved word-keyword association at a specific order position when the degrees of basic reserved word-keyword association corresponding to the specific reserved word are arranged in the order of their size. Another specific value having a positive correlation with the degrees of basic reserved word-keyword association corresponding to the specific reserved word may become the reference degree of basic reserved word-keyword association. The reference degree of basic reserved word-keyword association may vary depending on a reserved word, and may be the same for all reserved words. The deletion of the degree of basic reserved word-keyword association means that there is no degree of association between a reserved word and a representative keyword. The control unit 320 may set the degree of association to 0. Alternatively, the control unit 320 may delete the degree of basic reserved word-keyword association in such a manner as to delete information about the degree of basic reserved word-keyword association of a pair of the reserved word and the corresponding representative keyword in a list (which may be replaced with an array, or another data structure) showing the degrees of basic reserved word-keyword association. There may be used another method of adding information indicating that the degree of basic reserved word-keyword association has been deleted (or an associative relationship has been deleted).

Through the process of step 1530, the degree of basic reserved word-keyword association having a relatively slight degree of association is deleted (i.e., a setting is made such that there is no degree of association), and thus excessively complicated calculation may be prevented from being performed or an associative relationship substantially meaningless to a user/administrator may be prevented from being displayed.

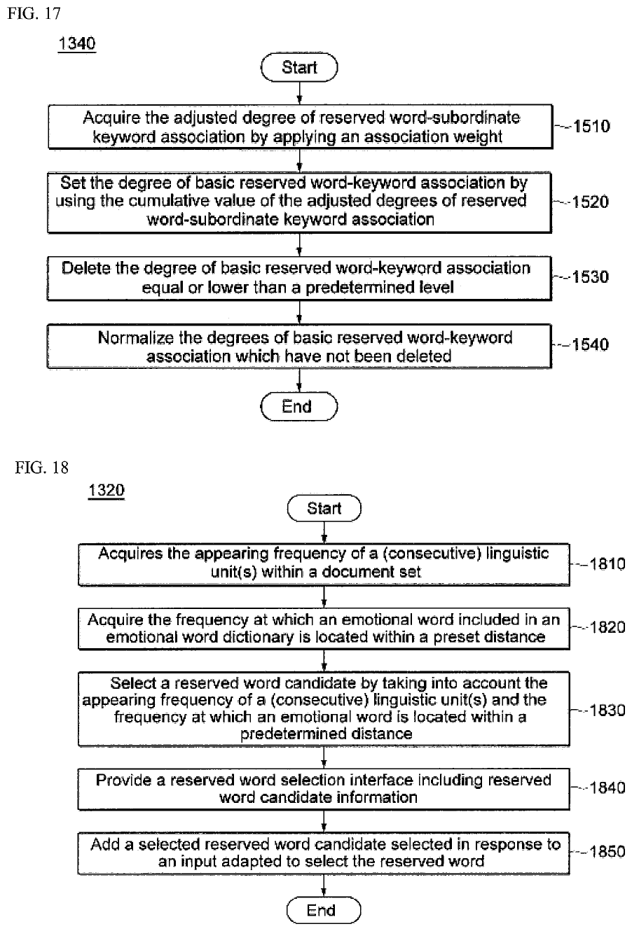

FIG. 17 is a detailed flowchart of step 1340 according to still another exemplary embodiment of the present disclosure.

Since the processes of steps 1510 and 1520 of FIG. 17 are the same as the processes described with reference to FIG. 15, redundant descriptions will be omitted. Furthermore, since the process of step 1530 of FIG. 17 is the same as the processes described with reference to FIG. 16, a redundant description will be omitted.

At step 1540, the control unit 320 may normalize the degrees of basic reserved word-keyword association which have not been deleted and remain. For example, in order to include the average value of the degrees of basic reserved word-keyword association, stored in connection with a specific representative attribute keyword, in a specific range, the degrees of basic reserved word-keyword association stored in connection with the specific representative attribute keyword may be increased or decreased by multiply the degrees of basic reserved word-keyword association by a predetermined coefficient. For example, in order to include the total sum of the degrees of basic reserved word-keyword association stored in connection with a specific representative attribute keyword in a specific range, the degrees of basic reserved word-keyword association stored in connection with the specific representative attribute keyword may be increased or decreased by multiplying the degrees of basic reserved word-keyword association by a predetermined coefficient. In other words, appropriate adjustment may be performed to prevent a case where only a specific representative attribute keyword is recommended/used or the specific representative attribute keyword is rarely used even when any reserved word is selected because the degree of basic reserved word-keyword association having a high value is concentrated on the specific representative attribute keyword.

According to another exemplary embodiment, at step 1540, the control unit 320 may perform normalizing by adding a predetermined coefficient to the degrees of basic reserved word-keyword association or applying a combination with an arithmetic operation, such as a log operation, an exponential operation, or the like in place of multiplying them by the predetermined coefficient. According to still another exemplary embodiment, the control unit 320 may perform normalizing in such a manner as to decrease only the degrees of basic reserved word-keyword association equal to or higher than a specific reference value or increase only the degrees of basic reserved word-keyword association equal to or lower than a specific reference value.

Furthermore, according to another exemplary embodiment, at step 1540, the control unit 320 may perform normalization in order to include the average value (or the total sum) of the degrees of basic reserved word-keyword association stored in connection with a specific reserved word in a specific range.

There may be possible a modified exemplary embodiment in which step 1530 is omitted in the process of FIG. 17 and the normalization of the degrees of basic reserved word-keyword association is performed.

At step 1350, the communication unit 310 acquires a received reserved word by receiving the received reserved word from the terminal 200, and transfers the received reserved word to the control unit 320.

The received reserved word is a reserved word which is received by the terminal 200 from a search user. The terminal 200 may convert a voice input into an electrical signal (a voice signal), and may transfer information to the provision device 300. The control unit 320 of the information provision apparatus 300 may convert the voice signal into a text by analyzing the voice signal, and may match the resulting text to a reserved word. Furthermore, the control unit 320 may analyze the intonation, pitch, tempo, respiration state, etc. of a voice by analyzing the voice signal, and may use analysis results as contextual information.

According to another exemplary embodiment, the terminal 200 may convert the voice input into a text, and may transfer the text to the information provision apparatus 300. The terminal 200 may analyze the intonation, pitch, tempo, respiration state of a voice, etc., and may transfer analysis information to the information provision apparatus 300. The information provision apparatus 300 may use the analysis information as a type of contextual information.

At step 1360, the control unit 320 acquires the degree of reserved word-object association corresponding to a pair of the received reserved word and each object item by using the degree of object-keyword association and the degree of basic reserved word-keyword association. The process of step 1360 may be performed according to the method of step 940 of FIG. 9 or the method of FIG. 12. The same descriptions will be omitted.

At step 1370, the control unit 320 may provide an object item according to the degree of reserved word-object association corresponding to the received reserved word. The process of step 1370 may be performed in the same manner as the process of step 950. The same descriptions will be omitted.

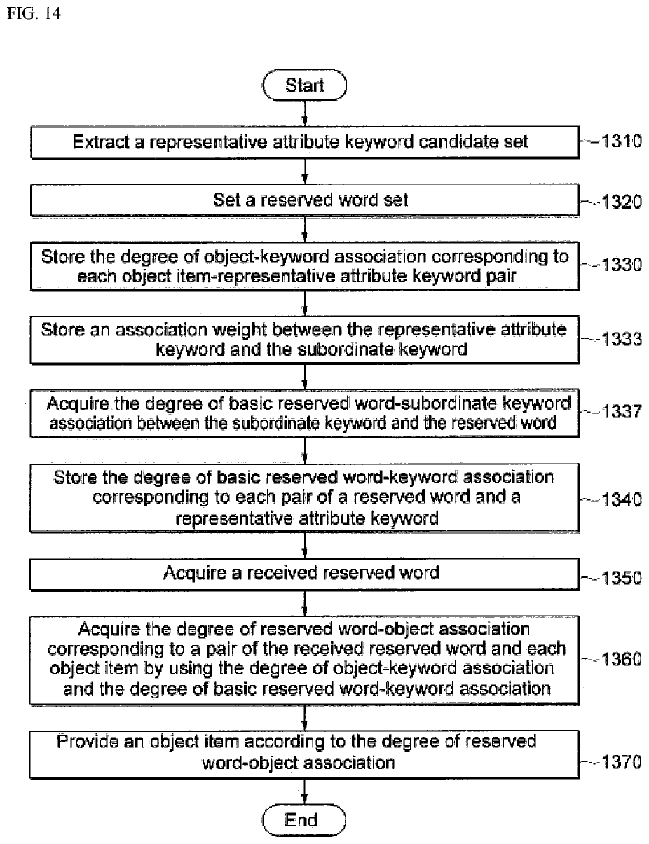

FIG. 14 is a flowchart of a process of providing information according to still another exemplary embodiment of the present disclosure.

Since steps 1310, 1320, 1330, 1340, 1350, 1360 and 1370 of FIG. 14 are the same as steps 1310, 1320, 1330, 1340, 1350, 1360 and 1370 of FIG. 13, the same description will not be repeated.

Step 1333 added to FIG. 14 may be performed at any time after a representative attribute keyword and a subordinate keyword have been determined. For example, step 1333 may be performed at the same time as/in parallel with step 1330, or may be performed during step 1330.

At step 1333, the control unit 320 stores an association weight between the representative attribute keyword and the subordinate keyword. In the case where the process of setting an association weight is not performed at step 1330, an association weight between the representative attribute keyword and the subordinate keyword may be set through a process identical or similar to the process of step 530 of FIG. 5. According to another exemplary embodiment, the control unit 320 may store an association weight between the representative attribute keyword and the subordinate keyword in such a manner as to retrieve the association weight set at step 1330.

At step 1337, the control unit 320 acquires the degree of basic reserved word-subordinate keyword association between the subordinate keyword and the reserved word.

The control unit 320 may determine the degree of association between the reserved word and the subordinate keyword, e.g., by taking into account the frequency at which the subordinate keyword appears in a context identical or similar to a context in which the reserved word appears. For example, words appearing in the vicinity of keyword A in a specific sentence may be viewed as appearing in the vicinity of words associated with the keyword A in other documents.

“I went on a trip after making a hard decision, but it was July and, thus, the weather was so hot that I suffered.”

“I went on a trip after making a hard decision, but it was July and, thus, the weather was so humid that I suffered.”

Referring to the above two sentences, the word “hot” is replaced with the word “humid” in the same context. The control unit 320 may infer that “hot” and “humid” are associated words.

“I went on a trip after making a hard decision, but it was July and, thus, the weather was so hot that I suffered.”

“I went on vacation after making a hard decision, but it was July and, thus, the weather was so hot that I suffered.”

In the same manner, the control unit 320 may infer from the above two sentences that “trip” and “vacation” are associated words.

“I went on a trip after making a hard decision, but it was July and, thus, the weather was so hot that I suffered.”

“I went on a trip after making a hard decision, but it was August and, thus, the weather was so hot that I suffered.”

In the same manner, the control unit 320 may infer that “July” and “August” are associated words.

The control unit 320 may stores information in which “hot” and “humid” are associated words, “July” and “August” are associated words, and “trip” and “vacation” are associated words via previously collected documents. Thereafter, it is assumed that the following sentences are collected.

“I went on vacation after making a hard decision, but it was July and, thus, the weather was so hot that I suffered.”

“I went on a trip after making a hard decision, but it was August and, thus, the weather was so hot that I went through hardship.”

When the two sentences do not have the same context but it is known that “hot” and “humid” are associated words, “July” and “August” are associated words, and “trip” and “vacation” are associated words, the control unit 320 may learn via the above sentences that “suffer” and “hardship” are also associated words.

It may be determined that a keyword pair having a high appearing frequency in the same/similar contexts has a high degree of association. Furthermore, it is determined that the higher the similarity between contexts in which two keywords appear is, the higher the degree of association between the two keywords is. The control unit 320 may increase the accuracy of the determination of the degrees of association between keywords in such a manner as to set the degrees of association keywords by performing learning by using collected documents and then setting the degrees of association between keywords appearing in a corresponding sentence by using the set degrees of association between keywords and the context of the sentence.

As similar learning methods, Neural Net Language Model (NNLM), Recurrent Neural Net Language Model (RNNLM), word2vec, skipgram, and Continuous Bag-of-Words (CBOW) methods are known. In particular, when the word2vec method is used, the word2vec method may map individual keywords to vectors by performing learning by using documents, and may determine the similarity between two keywords through the cosine similarity computation of two vectors.

FIG. 20 is a view of a terminology hierarchy according to an exemplary embodiment of the present disclosure.

Once the process of FIG. 13 or 14 has been completed, there are set the hierarchical relationship between reserved words C₁ to C_{q}, representative attribute keywords k₁ to kₙ, and subordinate keywords BX₁ to BX₅₀.

The degrees of basic reserved word-keyword association are set between the reserved words and the representative attribute keywords, and association weights are set between the representative attribute keywords and the subordinate keywords. Using this hierarchical relationship, the control unit 320 may perform the operation of recommending an appropriate object according to a reserved word, the operation of selecting a new reserved word candidate, or the like. Furthermore, the hierarchical relationship of FIG. 20 may be amended or improved by learning through the repetition of the process of FIG. 13 or 14, with new data being incorporated into the hierarchical relationship.

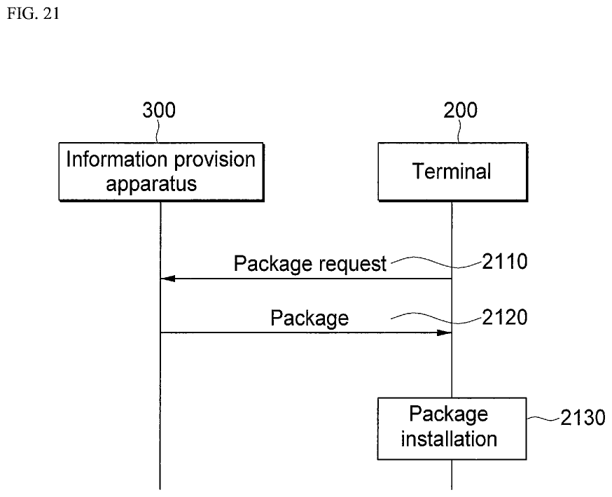

FIG. 21 is a flowchart of a process of installing a virtual input interface program according to an embodiment.

In step 2110, the terminal 200 transmits a package request message to the information provision apparatus 300. The package request message is a message requesting a virtual input interface program. In step 2120, the information provision apparatus 300 delivers the virtual input interface program (package) to the terminal 200.

In step 2130, the terminal 200 installs the received virtual input interface program (package). If the installation is unnecessary and the received virtual input interface program can be executed as it is, step 2130 may be omitted. The terminal 200 executes the virtual input interface program according to an input of the user to perform a method of recommending items based on areas.

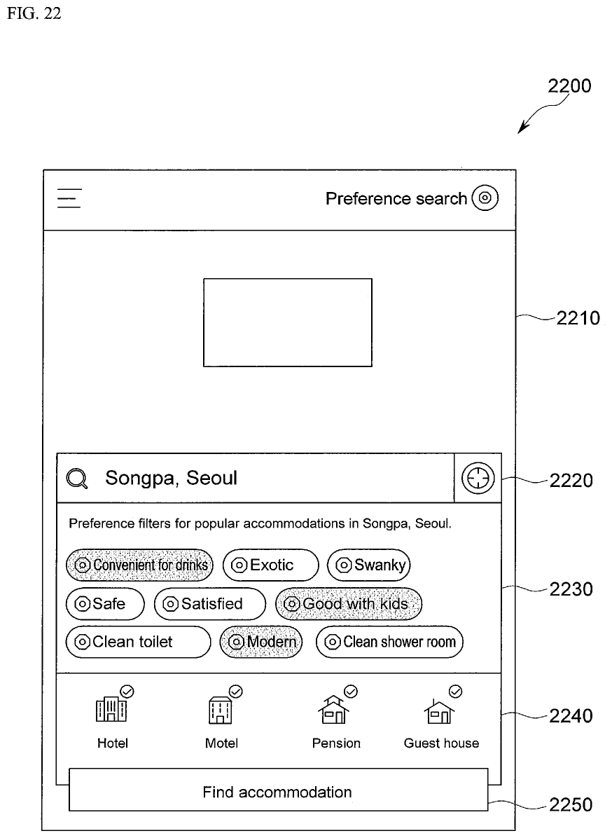

FIG. 22 is a view of an interface page of a package for performing a method of recommending items based on areas according to an embodiment.

Referring to FIGS. 4, 21, and 22, an interface page of the package for performing a method of recommending items based on areas according to an embodiment may be an interface page of the package installed in the terminal according to package installation (2130) in the terminal of FIG. 21.

Referring to FIG. 22, an interface page 2200 for performing a method of recommending items based on areas according to an embodiment may include a title display unit 2210, an area input part 2220, a preference filter selection part 2230, a category selection part 2240 and a search button 2250.

A preference filter, which is a kind of reserved words, may be a word, a phrase, or a sentence according to the contents of the invention, described above through FIGS. 1 to 20, and represents preferences, likings, and tastes of users.

The terminal 200 displays the interface page 2200 as the package installed in the terminal 200 is installed in the terminal 200 and is driven.

The interface page 2200 may be a whole page or a partial page of a program which is driven as the package is installed, and may be a page displayed by another web server connected to the program which is driven as the package installed in the terminal is installed.

Hereinbelow, controlling, by the control unit 250 of the terminal 200, over the display unit 220 so that the display unit 220 outputs contents, controlling, by the control unit 250 of the terminal 200, over the communication unit 230 so that the communication unit 230 communicates with the information provision apparatus 300, controlling, by the control unit 250 of the terminal 200, over the input unit 210 so that the input unit 210 receives the contents, or controlling, by the control unit 250 of the terminal 200, over the storage unit 240 so that the storage unit 240 stores the contents is to be described as that the terminal 200 is operated. The display unit 220 of the terminal 200 may be integrated with the input unit 210 to perform both functions of the input unit 210 and the display unit 220, and hereinbelow, it will be described that the functions of the input unit 210 are also performed by the display unit 220.

The terminal 200 may display a title of a current page, a title of a current program, and a description of the program in the title display unit 2210. For example, the terminal 200 may display “hang out,” which is the title of the current program, and “Select the traveler and preference filter. Accommodations that match your preference will be recommended” on the title display unit 2210. In the present embodiment, although it is described that accommodations are recommended, embodiments are not limited thereto, and various items other than accommodations, for example, restaurants, bars, billiard rooms, and play facilities, may be recommended.

The terminal 200 may display areas in the area selection unit 2220, and the user may select the displayed area or directly enter the area or sightseeing spot the user desires to travel. The area may be selected through a combo box, a radio box, or a list. In addition, the terminal 200 may locate the user through global positioning system (GPS) without the user having to input the area.

The terminal 200 displays, at the preference filter selection part 2230, the preference filters included in the accommodations located in the area input by the user, and receives the selection of preference filters from the user. The information provision apparatus 300 receives the area selected by the user from the terminal 200, and extracts the preference filter, which is a kind of reserved words, included in the accommodations located in the received area.

A predetermined number of preference filters may be extracted in descending order of the degree of association with the accommodations located in the area, and the extracted preference filters may be transmitted to the terminal 200.

For example, when the user inputs “Songpa, Seoul” in the area input part 2220, the preference filters included in the accommodations located in “Songpa, Seoul” are extracted from the information provision apparatus 300 in descending order of the degree of association between the preference filter and the accommodation, and the extracted preference filters are transmitted to the terminal 200 to be displayed at the preference filter selection part 2230.

The information provision apparatus 300 may obtain a list of accommodations for each area. The information provision apparatus 300 may calculate the degree of association with each preference filter for accommodations located in each area in the above-described manner. The degree of association between the corresponding area and the corresponding preference filter may be set by adding all the degrees of association with all accommodations located in the corresponding area with respect to a specific preference filter AA, or may be set so that the degree of association between the corresponding area and the corresponding preference filter has a positive correlation with a degree of association between the specific preference filter AA and all the accommodations located in the corresponding area. The information provision apparatus 300 may select the preference filters in descending order of the degree of association with the corresponding area and display them on the preference filter selection part 2230.

The degree of preference filter-accommodation association may be calculated according to the reserved word-object association described hereinabove with reference to FIGS. 1 to 20. Alternatively, as described above with reference to FIGS. 1 to 20, subordinate keywords for the preference filter may be extracted, and the degree of preference filter-accommodation association may be calculated according to the association between the subordinate keywords and the accommodation.

The user may select a part of the predetermined number of preference filters displayed at the preference filter selection part 2230. In a case where the user does not select any of the preference filters displayed at the preference filter selection part 2230, the terminal 200 determines that all of the preference filters displayed at the preference filter selection part 2230 are selected, and transmits all of the preference filters displayed at the preference filter selection part 2230 to the information provision apparatus 300.

The terminal 200 displays a category of the accommodation in the category selection part 2240. The category may be, for example, a hotel, a motel, a pension and a guest house. Although it is described as categories of accommodations in an embodiment of the present invention, embodiments are not limited thereto, and the category may be classified according to the characteristics or features of the items.

The user may select all or a part of the categories of the accommodations displayed at the category selection part 2240 and may only search for accommodations corresponding to the desired category. In a case where the user does not select any of the categories displayed at the category selection part 2240, it is to be considered that all the categories are selected.

When the user completes the selection of preference filters displayed at the preference filter selection part 2230 and the category displayed at the category selection part 2240, and then selects the search button 2250, the terminal 200 transmits the area, the category, and the preference filter to the information provision apparatus 300, and receives a recommendation result for accommodations from the information provision apparatus 300 to display it.

The recommendation result may be received and displayed in descending order of the degree of association with the preference filter selected by the user.

The preference filter associated with the accommodation is selected based on a distance between the accommodation and the preference filter in documents, the frequency of the accommodation and the preference filter being described at a time, or word2vec. The documents may include documents posted on SNS, portal sites, blogs, and Internet cafes.

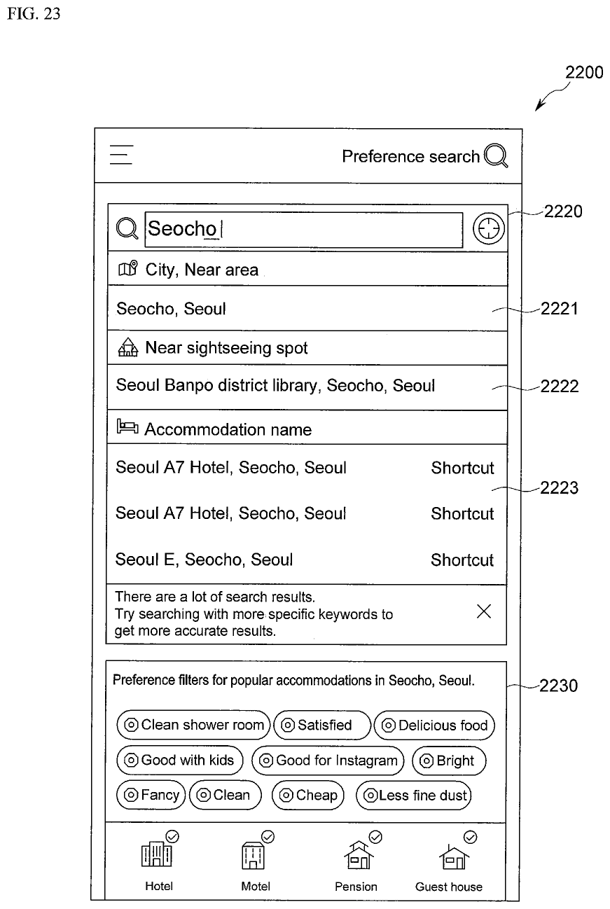

FIG. 23 is a view of an area input part of an interface page of a package for performing a method of recommending items based on areas according to an embodiment.

Referring to FIGS. 22 to 23, the area input part 2220 of the interface page for performing a method of recommending items based on areas according to an exemplary embodiment of the present disclosure may include an area selection unit 2221, a sightseeing spot selection unit 2222, and an accommodation selection unit 2223.

When the user inputs an area or a name of sightseeing spot into the area input part 2220, the area input part 2220 is expanded according to the area or the name of sightseeing spot input thereto, and the area selection unit 2221, the sightseeing spot selection unit 2222, and the accommodation selection unit 2223 may be displayed. The area selection unit 2221, the sightseeing place selection unit 2222, and the accommodation selection unit 2223 may all be displayed or only one of them may be displayed the area or the name of sightseeing spot input by the user.

An area such as a city or an administrative area related to the area input by the user is displayed at the area selection unit 2221, a sightseeing spot is displayed at the sightseeing spot selection unit 2222, and accommodations located at the area input by the user are displayed at the accommodation selection unit 2223.

When the user selects the area displayed at the area selection unit 2221, the sightseeing spot displayed at the sightseeing spot selection unit 2222, or the accommodation displayed at the accommodation selection unit 2223, the input unit 2220 that has been expanded is reduced and preference filters associated with the items selected by the user may be displayed at the preference filter selection part 2230. Alternatively, when the user selects the accommodation displayed at the accommodation selection unit 2223, information about the corresponding accommodation may be directly displayed, instead of the preference filter associated with the accommodation being displayed.

The user may select a part or all of the preference filters displayed at the preference filter selection part 2230 and may select a part or all of the categories displayed at the category selection part 2240.

When the user selects the search button 2250, the terminal 200 transmits the preference filter, the category and the area selected by the user to the information provision apparatus 300, and requests a recommendation for accommodations.

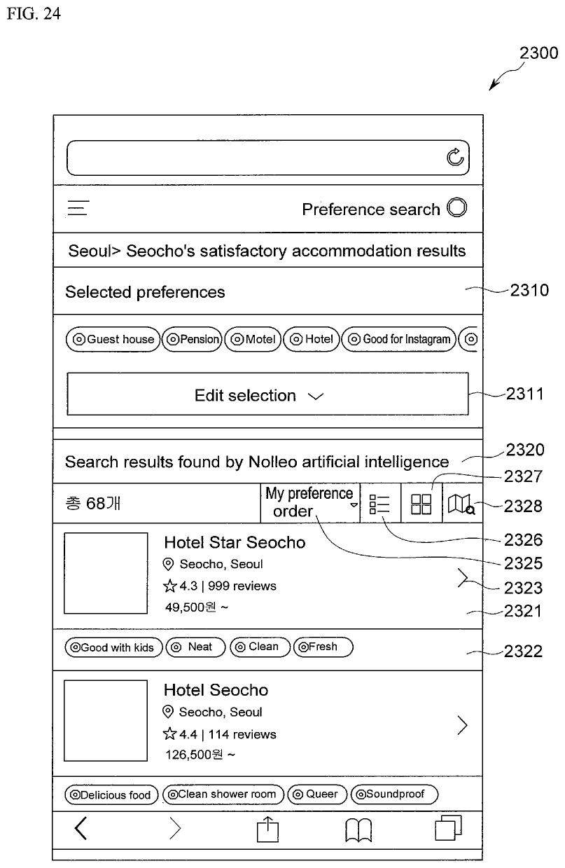

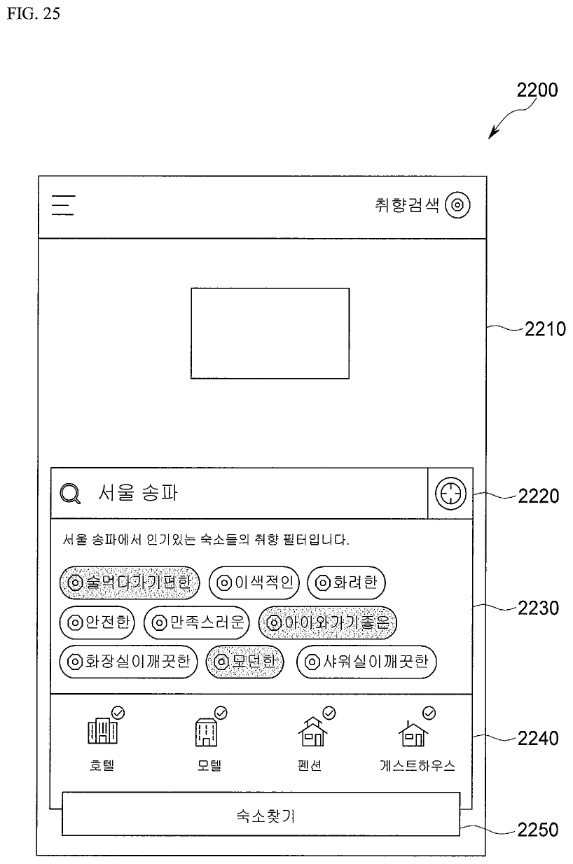

FIG. 24 is a view of an interface page of a package for performing a method of recommending items based on areas according to another embodiment.

Referring to FIGS. 22 and 24, an interface page 2300 of a package for performing a method of recommending items based on areas according to an exemplary embodiment of the present disclosure includes a preference filter display part 2310 and a recommendation result display part 2320.

The interface page 2300 may be displayed at the terminal 200 when the user selects the search button 2250 of FIG. 22.

The terminal 200 displays the preference filter, having been used for the search, at the preference filter display part 2310. The preference filter displayed at the preference filter display part 2310 may be deleted by pressing the preference filter for a predetermined time, or deletion or addition of a preference filter may be performed by selecting a selection item modification button 2311.

The terminal 200 displays, at the recommendation result display part 2320, a search result according to the preference filter selected by the user.

The information provision apparatus 300 receives the preference filter, the area and the category selected by the user from the preference filter selection part 2230, searches for accommodations based on the preference filter, the area and the category, and then sorts the recommendation result in descending order of the degree of association with the preference filter, i.e., the preference filter-accommodation association degree, and transmits the sorted result to the terminal 200. Alternatively, the terminal 200 may receive a recommendation result from the information provision apparatus 300 and sort the recommendation result.

The recommendation result display part 2320 includes an accommodation information display unit 2321 and a preference filter display part 2322. At the accommodation information display unit 2321, the name, the photo, the area, the evaluation score, the number of reviews, and the price range of the accommodation may be displayed. The accommodation information display unit 2321 may include a detailed information view button 2323 for displaying detailed information.

At the preference filter display part 2322, a preference filter included in the accommodation displayed at the accommodation information display unit 2321 is displayed.

The recommendation result display part 2320 may include a sorting button 2325 for sorting the recommendation results, a brief information display button 2326 for changing the information displayed at the accommodation information display unit 2321, an information non-display button 2327, and a map view button 2328.

The sorting button 2325 may include various sorting criteria such as a distance order, a my-preference order, a popularity order, an ascending order of price, a descending order of price, a rating order, and a review order, and when a sorting criterion is selected, the terminal 200 sorts the recommendation results according to the selected sorting criterion.

When the brief information display button 2326 is selected, the terminal 200 displays the accommodation information display unit 2321, including the name, the photo, the area, the evaluation score, the number of reviews, and the price range of the accommodation, and the preference filter display part 2322, at the recommendation result display part 2320.

When the information non-display button 2327 is selected, the terminal 200 displays the accommodation information display unit 2321, including only the photo of the accommodation, and the preference filter display part 2322, at the recommendation result display part 2320.

In such a case, the user may identify detailed information about the accommodation by selecting the photo included in the accommodation information display unit 2321.

When the map view button 2328 is selected, the recommendation result is displayed on a map, and a location of the recommended accommodation on the map may be identified.

As set forth hereinabove, an apparatus and a method of recommending items based on areas according to one or more embodiments of the present invention may recommend items according to an area, a preference filter, and a category input by a user.

In this case, it can be understood that individual blocks of the flowcharts and/or combinations of the blocks of the flowcharts may be performed by computer program instructions. Since it is possible to install these computer program instructions on a general-purpose computer, a special computer, or the processor of a programmable data processing device, the instructions executed through the computer or the processor of the programmable data processing device generate a means for performing functions which are described in the blocks of the flowcharts. Furthermore, since it is possible to store these computer program instructions in computer-usable or computer-readable memory that can be oriented to a computer or some other programmable data processing device in order to implement functions in a specific manner, it is possible to manufacture products in which instructions stored in computer-usable or computer-readable memory include means for performing functions described in the blocks of flowcharts. Moreover, since it is possible to install computer program instructions on a computer or another programmable data processing device, instructions for performing a series of operational steps on the computer or the programmable data processing device, generating processes executed by the computer and operating the computer or the programmable data processing device can provide steps for performing functions described in the blocks of flowcharts.

Furthermore, each block may refer to part of a module, a segment, or code including one or more executable instructions for performing one or more specific logical functions. Moreover, it should be noted that in some alternative embodiments, functions described in blocks may occur out of order. For example, two successive blocks may be actually performed at the same time, or sometimes may be performed in reverse order according to relevant functions.

In this case, the term “unit” used herein refers to a software or hardware component, such as an FPGA or ASIC, which performs a function. However, the term “unit” is not limited to a software or hardware component. The unit may be configured to be stored in an addressable storage medium, or may be configure to run one or more processors. For example, the unit may include components, such as software components, object-oriented software components, class components and task components, processes, functions, attributes, procedures, subroutines, segments of program codes, drivers, firmware, microcode, circuits, data, databases, data structures, tables, arrays, and variables. Functions provided by components and units may be combined into a smaller number of components and units, or may be divided into a larger number of components and units. Furthermore, components and units may be each implemented to run one or more CPUs within a device or security multimedia card.

It will be understood by those having ordinary knowledge in the art to which the present disclosure pertains that the present disclosure may be practiced in other specific forms without changing the technical spirit or essential feature of the present disclosure. Therefore, the above-described embodiments should be understood as being illustrative, not limitative, in all aspects. The scope of the present disclosure is defined based on the attached claims rather than the detailed description, and the claims, equivalents to the claims, and all modifications and alterations derived from the claims and the equivalents should be construed as being included in the scope of the present disclosure.

Meanwhile, although the exemplary embodiments of the present disclosure have been disclosed in the present specification and the accompanying drawings and the specific terms have been used, this is intended merely to easily describe the technical spirit of the present disclosure and help to understand the present disclosure, but is not intended to limit the scope of the present disclosure. It will be apparent to those having ordinary knowledge in the art to which the present invention pertains that other modified exemplary embodiments based on the technical spirit of the present invention may be implemented in addition to the disclosed exemplary embodiments.

What is claimed is:

1. An apparatus of recommending items based on areas, the apparatus comprising:
a display unit for displaying an interface page, the interface page comprising:
an area input part for receiving an input of an area,
a preference filter selection part for displaying preference filters associated with the input area and items of the input area, and receiving a selection of preference filters, and
a category selection part for receiving a selection of categories associated with the item; and
a control unit for controlling the display unit and transmitting the input area, the selected preference filter, the selected category to an information provision apparatus.

2. The apparatus of claim 1, wherein the item is an accommodation.

3. The apparatus of claim 2, wherein the category is at least one of a hotel, a motel, a pension, and a guest house.

4. The apparatus of claim 1, wherein a predetermined number of preference filters are displayed in descending order of a degree of preference filter-item association in the area.

5. The apparatus of claim 1, wherein the display unit further comprises:
a preference filter display part for displaying the selected preference filter; and
a recommendation result display part for receiving, from the information provision apparatus, an item that has a high degree of preference filter-item association with the selected preference filter in the area, and displaying the item.

6. The apparatus of claim 5, displaying an item that is recommended as a part of the selection of preference filters is canceled, or as a preference filter is added.

7. The apparatus of claim 1, wherein the preference filter associated with the item is selected based on at least one of a distance between the item and the preference filter and a frequency of the accommodation and the preference filter being described at a time in documents.

8. A method of recommending items based on areas performed by apparatus, the method comprising:
receiving an area selected by a user;
calculating a degree of association of preference filters to items in the area to determine preference filters; and
transmitting, to a terminal, a predetermined number of preference filters of the determined preference filters.

9. The method of claim 8, further comprising:
receiving a selection of preference filters of the preference filters transmitted to the terminal.

10. The method of claim 9, further comprising:
receiving a category for the item.

11. The method of claim 10, further comprising:
recommending items based on the selected preference filter, the area, and the category and transmitting the recommending items.

12. The method of claim 11, wherein the items are recommended and transmitted in descending order of a degree of preference filter-item association.

13. The method of claim 12, wherein the item is an accommodation.

14. The method of claim 12, wherein the category is at least one of a hotel, a motel, a pension, and a guest house.

15. The method of claim 8, wherein a predetermined number of preference filters are displayed in descending order of a degree of preference filter-item association in the area.

16. The method of claim 8, wherein the preference filter associated with the item is selected based on at least one of a distance between the item and the preference filter and a frequency of the accommodation and the preference filter being described at a time in documents.

17. The method of claim 12, wherein a degree of association of a preference filter to the area is calculated by adding degrees of association between the preference filter and all accommodations in the area.

18. The method of claim 12, wherein a degree of association of a preference filter to the area is set to have a positive correlation with degrees of association between the preference filter and all accommodations in the area.
